(19) United States
(12) Patent Application Publication
(10) Pub. No.: US 2015/0055319 A1
(43) Pub. Date: Feb. 26, 2015

(54) WAVELENGTH CONVERSION STRUCTURE FOR A LIGHT SOURCE

(71) Applicant: OSRAM SYLVANIA Inc., Danvers, MA (US)

(72) Inventors: Nathan Zink, North Andover, MA (US); Krister Bergenek, Regensburg (DE); Madis Raukas, Lexington, MA (US)

(21) Appl. No.: 14/388,475

(22) PCT Filed: Mar. 14, 2013
(86) PCT No.: PCT/US13/31654

§ 371 Date: Sep. 26, 2014

Related U.S. Application Data
(60) Provisional application No. 61/618,704, filed on Mar. 31, 2012.

(51) Int. Cl. F21K 99/00; F21V 9/08; F21V 9/16

(52) U.S. Cl. CPC F21K 9/56; F21V 9/16; F21V 9/08; F21Y 2101/02
USPC 362/84; 362/317

(57) ABSTRACT

A wavelength conversion structure for a light source including a solid-state light-emitting device. The wavelength conversion structure includes one or more apertures formed therein. The apertures may permit color steering of the light downstream of the conversion structure without a substantial reduction in the output of secondary light produced during a conversion process.

### CROSS-REFERENCE TO RELATED APPLICATIONS

This application claims the benefit of U.S. Provisional Application No. 61/618,704, filed Mar. 31, 2012, the contents which is incorporated herein by reference.

### BACKGROUND

Solid state light sources such as light emitting diodes (LEDs) generate visible or non-visible light in a specific region of the electromagnetic spectrum. An LED may output light, for example, in the blue, red, green or non-visible ultra-violet (UV) or near-UV region(s) of the electromagnetic spectrum, depending on the material composition of the LED. When it is desired to construct an LED light source that produces a color different from the output color of the LED, it is known to convert the LED light output having a peak wavelength (“primary light”) to light having a different peak wavelength (“secondary light”) using photoluminescence.

Photoluminescence generally involves absorbing higher energy primary light with a wavelength conversion plate (hereafter, a “converter”) including a wavelength converting material (hereafter, “conversion material”) such as a phosphor or mixture of phosphors. Absorption of the primary light excites the conversion material to a higher energy state. When the conversion material returns to a lower energy state, it emits secondary light, generally of a longer wavelength than the primary light. The peak wavelength of the secondary light can depend on the composition of the conversion material. This process may be generally referred to as “wavelength conversion.” An LED combined with a converter that includes a conversion material such as phosphor to produce secondary light may be described as a “phosphor-converted LED” or “wavelength-converted LED.”

In a known configuration, an LED die such as a group III nitride die is positioned in a reflector cup package and a volume. To convert primary light to secondary light, a converter may be provided. The converter structure may take the form of a self supporting “plate” such as a cured (hardened) mixture of phosphor powder(s) in silicone, a ceramic plate or a single crystal plate, a dome, a thin film, or some other form. In any case, the converter may be attached directly to the LED, e.g. by wafer bonding, sintering, gluing, etc. Such a configuration may be understood as “chip level conversion” or “CLC.” Alternatively, the plate may be positioned remotely from the LED. Such a configuration may be understood as “remote conversion.”

One drawback that may be associated with known converters is that the converter may emit secondary light at an undesired “color point.” As used herein, the term “color point” refers to one or more points on the CIE 1931 color space created by the International Commission on Illumination (CIE). Interest has therefore grown in the development of mechanisms for adjusting the color point of light produced by a wavelength-converted LED.

In this regard, it is known that for converters containing a given conversion material composition, the color point of the wavelength-converted LED may be adjusted by controlling the microstructure of the converter. In the case of a wavelength-converted LED using blue primary light and a converter containing a cerium-activated yttrium aluminum garnet (YAG:Ce) or lutetium aluminum garnet (LuAG:Ce) as a ceramic conversion material, for example, the amount of blue primary light that may pass through the converter may be raised or lowered by decreasing or increasing the porosity of the converter, respectively. Such adjustments to porosity (and other microstructural features) may be made, for example, by raising or lowering the temperature at which the converter is sintered during its manufacture. Alternatively or additionally, the amount of unconverted blue primary light passing through the converter may be raised or lowered by decreasing or increasing the thickness of the converter, respectively. In either case, such methods can shift the color point of the wavelength-converted LED.

Although effective to shift the color point of a wavelength-converted LED, increasing the amount of primary light passing through the converter using the aforementioned methods may come at the expense of reducing the amount of secondary light produced by the converter. That is, as the amount of unconverted primary (e.g. blue) light passing through the converter increases, the amount of secondary light produced by the converter decreases, and vice versa. In instances where the primary (e.g., blue) light is less luminous than the secondary (e.g., yellow) light, this can cause an undesirable reduction in luminous output (or efficacy) of the wavelength-converted LED light source.

In addition, the aforementioned methods may not address problems associated with the distribution of secondary light emission from the converter, i.e., the fact that light produced near the edge of the converter may not be the same color as light produced nearer to the center of the converter. For example, a wavelength-converted LED light source that uses blue primary light may produce light having a blue middle spot and a yellow halo. As a result, such source may produce light having an undesirable far-field pattern or angular profile.

### BRIEF DESCRIPTION OF THE DRAWINGS

Reference is now made to the following detailed description which should be read in conjunction with the following figures, wherein like numerals represent like parts and in which:

FIG. 1 diagrammatically illustrates in cross section an exemplary wavelength-converted LED assembly including a wavelength conversion plate consistent with the present disclosure;

FIG. 2 diagrammatically illustrates in cross section another exemplary wavelength-converted LED assembly including a wavelength conversion plate consistent with the present disclosure;

FIGS. 3A and 3B diagrammatically illustrate in cross section exemplary embodiments of wavelength conversion plates consistent with the present disclosure;

FIGS. 4A, 4B, and 4C diagrammatically illustrate in cross section additional exemplary embodiments of wavelength conversion plates consistent with the present disclosure;

FIG. 5 diagrammatically illustrates a top view of an exemplary wavelength conversion plate consistent with the present disclosure;

FIG. 6 diagrammatically illustrates a top view of another exemplary wavelength conversion plate consistent with the present disclosure;

FIGS. 7 and 8 diagrammatically illustrate in perspective view other exemplary wavelength conversion plates consistent with the present disclosure;

FIG. 9 illustrates several aperture arrangements that may be used in accordance with the present disclosure;

FIGS. 10-12 show emission spectra for wavelength conversion plates of different thicknesses;

FIG. 13 shows a plot of Cy vs. Cx color coordinates measured from several exemplary wavelength conversion plates consistent with the present disclosure;

FIG. 14 shows a plot of efficacies of several wavelength conversion plates consistent with the present disclosure;

FIGS. 15-18 each show a plot of a subset of data presented in FIGS. 13 and 14;

FIG. 19 shows a plot of percent conversion surface area (SA) vs. number of holes;

FIGS. 20A-20C show emission spectra for additional wavelength conversion plates of different thickness;

FIG. 21 shows a plot of Cx vs. converter thickness and number of holes, based on data measured from samples consistent with the present disclosure.

FIG. 22 shows a plot of LPW Opt Blue vs. converter thickness and number of holes, based on data measured from samples consistent with the present disclosure;

FIG. 23 shows a plot of chip quantum efficiency vs. converter thickness and number of holes, based on data measured from samples consistent with the present disclosure;

FIG. 24 shows a plot of blue optical power vs. thickness and number of holes, based on data measured from samples consistent with the present disclosure;

FIG. 25 shows a plot of yellow optical power vs. thickness and number of holes, based on data measured from samples consistent with the present disclosure;

FIG. 26 shows a plot of total optical power vs. thickness and number of holes, based on data measured from samples consistent with the present disclosure;

FIG. 27 shows a plot of conversion efficiency, blue, yellow, and total optical power, vs. thickness and number of holes, based on data measured from samples consistent with the present disclosure;

FIG. 28 shows a plot of LPW opt blue, blue, yellow, and total optical power vs. thickness and number of holes, based on data measured from samples consistent with the present disclosure;

FIG. 29 shows a plot of conversion efficiency vs. Cx value, based on data measured from samples consistent with the present disclosure; and

FIG. 30 shows a plot of total optical power vs. Cx value, based on data measured from samples consistent with the present disclosure.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient. Also, it should be understood that the phraseology and terminology used herein is for the purpose of description and should not be regarded as limiting.

### DETAILED DESCRIPTION

As used herein, the terms “about” and “substantially,” when used in connection with a numerical value or range means +/−5% of the recited numerical value or range.

From time to time, one or more aspects of the present disclosure may be described using a numerical range. Unless otherwise indicated herein, any recited range should be interpreted as including any iterative values between indicated endpoints, as if such iterative values were expressly recited. Such ranges should also be interpreted as including any and all ranges falling within or between such iterative values and/or recited endpoints, as if such ranges were expressly recited herein.

In the context of the present disclosure, references to the color of a phosphor, LED or conversion material refer generally to its emission color unless otherwise specified. Thus, a blue LED emits blue light, a yellow phosphor emits yellow light and so on.

The term “aperture” is used herein to refer to a structure formed in a converter that is defined by hole that extends partially or completely through the thickness of the converter. Apertures that comprise a through hole extending through the entire thickness of a converter include two open ends, and may be referred to herein as forming an “opening,” “passageway,” or “hole” in the converter. Apertures that include a hole that extends only part way through the thickness of a converter include a single open end, and are referred to herein as a “cavity” in the converter. The term “hole” is therefore used herein to describe any structure that extends through all or a portion of the thickness of a converter.

One aspect of the present disclosure relates to wavelength conversion plates (hereafter referred to as a “converter” for convenience) that include one or more apertures formed therein. The converter may be included in a light module such as a wavelength-converted LED assembly, wherein primary light emitted by an LED impinges on a bottom surface of the converter. The converter includes conversion material that converts at least a portion of the incident primary light to secondary light. As will be described in detail below, the aperture(s) in the converter may be configured to transmit or otherwise allow some portion of unconverted primary light emitted by the LED to pass through the converter. Although not required, the secondary and primary light may then pass from the converter through additional optics, such as a diffuser.

The converters described herein may provide numerous advantages. For example, the aperture(s) in the converter may permit higher transmission of unconverted primary light, as compared to an identical converter that does not include any apertures. The apertures described herein may therefore allow the production of converters that produce a light output having a color point shifted towards the wavelength of the primary light. In some embodiments, this shift or “steering” of the color point may be achieved while substantially maintaining the amount of secondary light produced by the converter. The aperture(s) may also conveniently allow additional phosphor components to be added to the converter, e.g., by filling the apertures with another conversion material, and/or adding a separate layer of conversion material to the top or bottom of the converter. Moreover, the aperture(s) may also permit the production of wavelength-converted LED assemblies that produce more homogenous light, relative to assemblies that use a converter lacking such aperture(s).

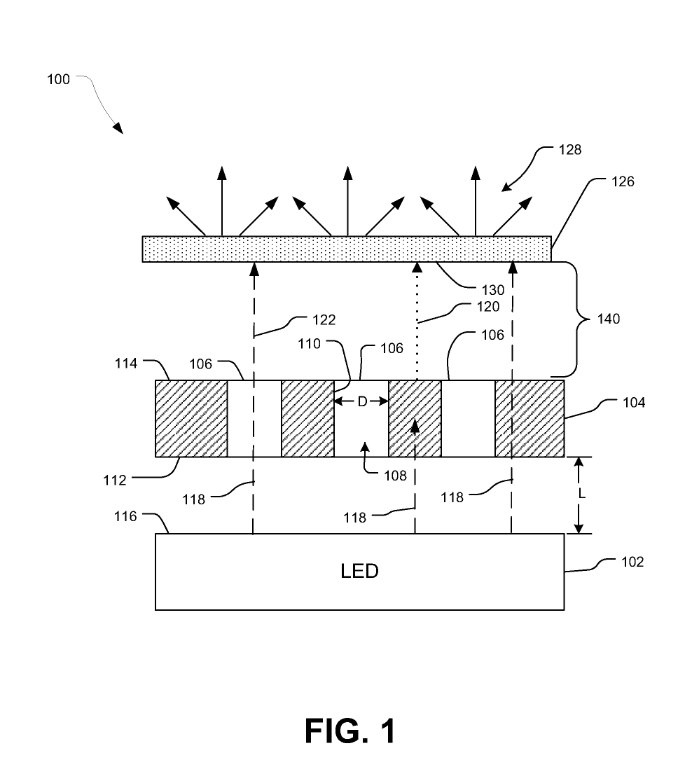

Turning now to the figures, FIG. 1 generally illustrates in cross section one embodiment of a light module configured as wavelength-converted LED assembly 100 (hereafter “assembly 100”) consistent with the present disclosure. As shown, assembly 100 includes LED 102 and a converter 104 having a plurality of apertures 106 defined therein.

LED 102 may be any LED capable of serving as a light source, and which is capable of emitting primary light at a desired wavelength or within a desired wavelength range of the electromagnetic spectrum. For example, LED 102 may be a blue LED or laser diode that emits primary light in a wavelength range from about 420 nm to about 490 nm, such as from about 450 nm to about 475 nm. Non-limiting examples of suitable LEDs that may be used in accordance with the present disclosure include nitride III-V LEDs, such as an InGaN LED. An InGaN LED may be understood as one exemplary type of LED that may produce blue primary light.

While FIG. 1 depicts a configuration in which a single LED 102 is used, it should be understood that assembly 100 may include any number of LEDs, including an array of LEDs. Alternatively or additionally, assembly 100 may include a laser diode serving as a light source. In any case, LED 102 (and/or a laser diode) may be coupled to a light guide to form a surface emitter.

Converter 104 may be positioned relative to LED 102 so that primary light 118 emitted from light emitting surface 116 may be incident on bottom surface 112. In this exemplary embodiment, converter 104 is depicted as being positioned a distance L from LED 102. As such, FIG. 1 may be understood as illustrating assembly 100 in a “remote phosphor” configuration. Distance L may be set according to desired operating conditions and performance. In some embodiments, distance L ranges from about 0.1 mm to about 3 mm, such as about 0.5 mm to about 2 mm, or even about 0.5 mm to about 1 mm. In any case, converter 104 may be supported within the assembly 100 by any known means, including support from a portion of a housing (not shown) of the assembly 100.

Of course, converter 104 need not be placed remotely from LED 102. Indeed, the present disclosure envisions embodiments wherein converter 104 is disposed directly on top of LED 102. In such instances, converter 104 may be directly in contact with emitting surface 116. Alternatively, converter 104 may be disposed on an index matching layer (not shown) present on emitting surface 116. In such instances, assembly 100 may be understood as having a chip-level-conversion (“CLC”) configuration.

Converter 104 may have any configuration suitable for a wavelength-converting plate. Converter 104 includes one or more wavelength-converting materials (“conversion materials). The type, number, and distribution of conversion materials in converter 104 may be selected so as to achieve a desired wavelength conversion, conversion efficiency, and/or a desired color point. The distribution and/or pattern, as well as size, of the conversion material may also be controlled to achieve desired near and/or far field optical performance, such as near and far field light distribution. Converter 104 may also include one or more structural features, such as a cut-out or notch, which may be used to facilitate its coupling, bonding (e.g., wire bonding), or other attachment/support to or within assembly 100.

In some embodiments, converter 104 is formed entirely of ceramic conversion material(s). Accordingly, converter 104 may be in the form of a ceramic conversion plate (or platelet). Such components may be manufactured by sintering a ceramic conversion material or mixture of materials into a unitary structure, or by some other mechanism. Converter 104 may also be formed by dispersing one or more conversion materials (e.g., as a powder) in a host material (also referred to herein as a “binder.”) Non-limiting examples of binders that may be used for this purpose include silicone, optical quality silicone, an epoxy, an acrylic, glass, combinations thereof, and the like.

Phosphors are one exemplary type of conversion material that may form or be included in the converters described herein. As may be generally understood by one skilled in the art, a phosphor is a compound capable of emitting, upon excitation by an external energy source (e.g., primary light), useful quantities of radiation (e.g., secondary light”) in the visible region of the electromagnetic spectrum. Non-limiting examples of suitable phosphors that may be used in the converters described herein include yellow phosphor, green phosphor, red phosphor, and/or combinations thereof.

In some embodiments, the conversion material(s) used in the converter include(s) one or more inorganic phosphor compounds that include a host material doped with a small amount of an activator ion. Non-limiting examples of phosphors that may be used in accordance with the present disclosure include oxyfluorates, nitrides (including oxynitride phosphors), and oxide phosphors (for example aluminate garnets, silicates etc.), including those containing cerium, gadolinium, scandium, europium, and/or other elements. In some embodiments, the conversion materials are chosen from cerium-activated yttrium aluminum garnets (YAG:Ce), cerium-activated yttrium gadolinium aluminum garnets (YGdAG:Ce), cerium-activated lutetium aluminum garnets (LuAG:Ce), europium- or cerium-activated alkaline earth (AE) silicon oxynitride (AE-SiON, where AE designates at least one element selected from Ba, Sr, and Ca), europium- or cerium-activated metal-SiAlON (M-SiAlON, where M is chosen from alkali ions, rare earth ions, alkaline earth ions, Y, Sc, and combinations thereof), and the like.

In some embodiments, the conversion material is or includes YAG:Ce, LuAG:Ce, or a combination thereof. Without limitation, YAG: Ce may be understood as one type of conversion material that can emit yellow secondary light in response to its excitation by (e.g., absorption of) blue primary light. The amount of activator ion may vary widely, e.g., from greater than 0 to about 10 atomic %, such as about 1 to about 5 atomic %, or even about 1 to 2 atomic percent.

The converters described herein may include multiple conversion materials. In such instances, the conversion materials may be distributed homogenously, inhomogenously, and/or randomly within the converter. Likewise, the conversion material(s) used may be present in the converter in a desired distribution and/or pattern.

The converters described herein may further include one or more apertures. This concept is illustrated in FIG. 1, wherein converter 104 includes a plurality of apertures 106, each of which is illustrated as including a corresponding through hole 108. In this embodiment, through hole 108 has a diameter D and a sidewall 110 that extends through the entire thickness of converter 104. That is, sidewall 110 extends from bottom surface 112 of converter 104 to top surface 114 of converter 104. Apertures 106 (and through holes 108) may therefore be understood as forming one or more openings, passageways, and/or holes through converter 104.

It should be understood that configuration of converter 104 in FIG. 1 is exemplary only, and that various modifications to the layout, geometry, thickness, etc. of converter 104 may be made to achieve desired performance characteristics. Thus for example, converter 104 may include any number (e.g., 1, 2, 3, 4, 5, etc.) of apertures 106. Likewise, some of apertures 106 (and through holes 108) may form an opening/hole/passageway through converter 104, whereas others may form a cavity. Similarly, sidewalls 110 of through holes 108 need not have a smooth or polished surface, as shown in FIG. 1. Indeed, all or a portion of the sidewalls of the apertures and through holes of the present disclosure may be textured, i.e., roughened as compared to a smoothed or polished surface.

With further reference to FIG. 1, bottom surface 112 of converter 104 may be substantially flat, and may be positioned in opposed facing relationship to emitting surface 116 of LED 102. Like sidewalls 110, bottom surface 112 of the converter 104 and emitting surface 116 of LED 102 may have substantially different (roughened, structured, etc.) character from the indicated flat/polished surfaces, depending on desired optical out-coupling and in-coupling.

Emitting surface 116 of LED 102 may operate to emit primary light 118. Such primary light may be emitted by emitting surface 116 such that it is incident on bottom surface 112 of converter 104. All or a portion of primary light 118 may pass into and through the bottom surface 112 of converter 104, where it may interact with and excite conversion material within converter 104. The excited conversion material may then emit secondary light 120, e.g., from top surface 114 of converter 104. Of course, secondary light 120 may also be emitted from other portions of converter 104, such as but not limited to sidewalls 110 of apertures 106, a side of converter 104, etc.

The secondary light produced by the converters described herein is light that is of a different wavelength than the primary light produced by an LED. Thus for example, primary light 118 may be blue light in a wavelength range of about 400 to about 470 nm, such as about 425 to 475 nm, or more specifically, from about 440 to about 460 nm, and secondary light 120 may be yellow or yellow-green light in a wavelength range of about 520 to about 590 nm, such as about 570 to about 590 nm. Of course, other colors and wavelength ranges may be used for the primary and secondary lights in accordance with the present disclosure. For example, the secondary light may be within a wavelength range of about 470 to about 800 nm.

In some embodiments, a converter in accordance with the present disclosure may be configured to convert greater than or equal to about 95% of primary light that enters the converter to secondary light. Thus for example, converter 104 in FIG. 1 may be configured to convert about 95 to about 100%, such as about 96 to about 100%, about 97 to about 100%, about 98 to about 100%, or even about 99 to about 100% of primary light 118 that enters converter 104 to secondary light 120.

The apertures of the present disclosure may be configured to allow a portion of primary light emitted by an LED to be transmitted or otherwise allowed to pass through a converter without being incident on surface thereof. This concept is illustrated in FIG. 1 by hashed line 122, which represents the passage of primary light 118 through an aperture 106 and through hole 108 without contacting a surface (e.g., sidewalls 110 or bottom surface 112) of converter 104. In this case, hashed line 122 depicts primary light 118 as passing entirely through converter 104, i.e., from bottom surface 112 to top surface 114 without being incident on any surface of converter 104.

Of course, the light pathway represented by hashed line 122 is exemplary only, and is not required. Indeed, depending on the angular orientation of the primary light emitted by LED 102 relative to converter 104, some primary light 118 may be incident on and reflected by sidewall 110 of a through hole 108 and/or an aperture 106. Alternatively or additionally, some portion of primary light 118 may enter converter 104 through sidewall 110 of through hole 106. In such instances, primary light 118 entering converter 104 in this manner may be converted to secondary light 120, or it may be pass unconverted through converter 104.

Assembly 100 may further include diffuser 126. Generally, diffuser 126 may be configured to mix secondary light 120 and primary light 118 passing through converter 104 to produce output light 128 with desired color uniformity. Output light 128 may have particular color or spectral characteristics, which may depend on the composition of the conversion material in converter 104. In some embodiments, output light 128 may be white light and/or light in a specific region of the electromagnetic spectrum, e.g., the visible region, the infrared region, the ultraviolet region, etc. Likewise, output light 128 may be polarized or unpolarized.

Diffuser 126 may also be configured to reduce the angular color spread of secondary light 120 and primary light 118 passing through converter 104, so as to produce output light 128 with a desired angular color spread and or illumination pattern. Diffuser 126 may therefore include a material having a size, shape and/or refractive index chosen to allow reduced color angular spread of the secondary light 120 and primary light 118 passing through converter 104, as compared to the angular color spread of such light in the absence of diffuser 126. For example, diffuser 126 may include a ground glass diffuser, holographic diffuser, or microlens diffuser. In addition, a polygonal/circular TIR or mirror reflector may be used to perform color mixing. In this way, diffuser 126 may address any increase in inhomogeneity of angular color distribution that may arise due to the presence of apertures 106 and through holes 108. Diffuser 126 may also be positioned a distance 140 from top surface 114 of converter 104. Distance 140 may be any suitable distance, such as about 1.0 mm to about 20 mm, or even about 1.0 mm to about 10 mm.

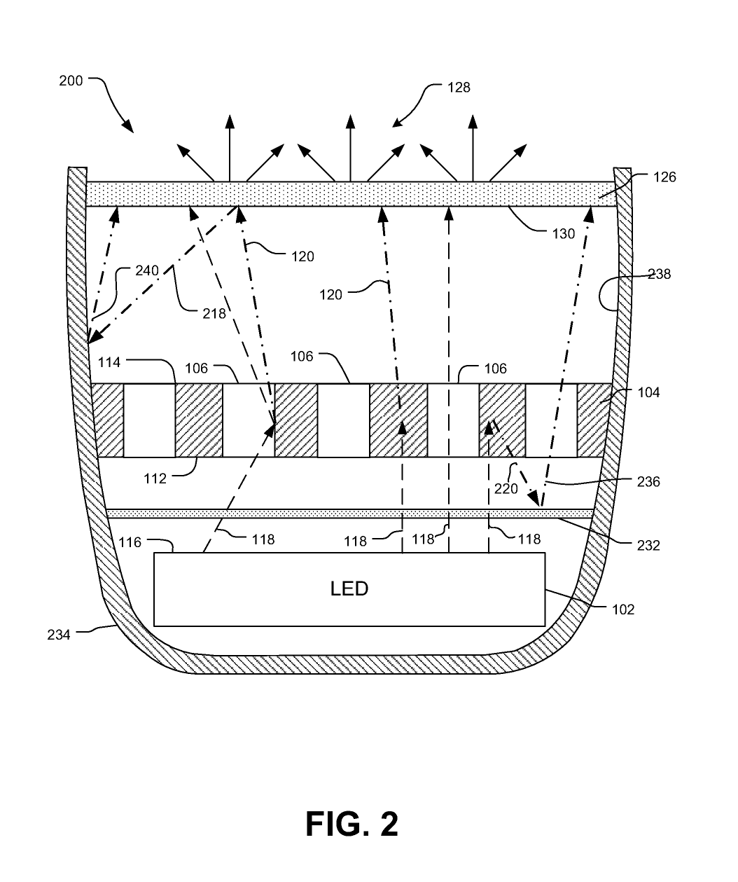

FIG. 2 illustrates another exemplary embodiment of a wavelength-converted LED assembly 200 (“assembly 200”) consistent with the present disclosure. In addition to many of the components of assembly 100 (discussed above in connection with FIG. 1), assembly 200 includes structures 232 and 234, which may be configured to redirect back scattered light. Back scattered light may be generally understood to mean light that is scattered back towards a direction from which the light was emitted. Thus, back scattered light may include all light that is scattered or reflected away from converter 104 and/or diffuser 126 in the direction of LED 102. For example, backscattered light may include backscattered secondary light 220 and/or backscattered primary light 218. As shown, backscattered secondary light 220 may be secondary light 120 that is produced by converter 104, but which is scattered back towards LED 102 instead of towards diffuser 126. Similarly, backscattered primary light 218 may include primary light 118 that is scattered back towards LED 102, e.g., after impinging on a surface of converter 104 and/or diffuser 126.

In some embodiments, structure 232 is an optical filter that is configured to selectively transmit primary light 118 while reflecting secondary light 120, including backscattered secondary light 220. In this way, structure 232 may redirect backscattered secondary light 220 in a direction away from LED 102, as generally indicated by arrow 236. In particular, filter 232 may be configured to reflect backscattered secondary light 220 in a direction away from LED 102, as indicated by arrow 236. While structure 232 is depicted in FIG. 2 as located between LED 102 and converter 104, such positioning is exemplary only and structure 232 may be placed in any suitable location. For example, structure 232 may be coupled directly to light emitting surface 116 of LED 102. Alternatively or additionally, structure 232 may be positioned between top surface 114 of converter 104 and bottom surface 130 of diffuser 126. For example, structure 232 may be configured as a dichroic filter, thin-film filter, interference filter, and/or a combination thereof.

In some embodiments, structure 234 is configured as a reflector, i.e., as an object having one or more surfaces that highly reflect one or more wavelengths of light. As used herein, the term “highly reflect” means when used in the context of a reflector means that the reflector and/or a surface thereof reflects greater than or equal to about 90% of light of a given wavelength or wavelength range. Thus for example, the reflectors described herein may be configured to highly reflect primary light, backscattered primary light, secondary light, backscattered secondary light, and combinations thereof. In the embodiment shown in FIG. 2 for example, structure 234 is configured as a reflector that re-directs backscattered primary light 220 in a direction away from the LED 102 (e.g., towards diffuser 126), as generally shown by arrow 240. To this end, structure 234 may include a reflective inner surface 238 which is highly reflective to one or more of primary light 118, secondary light 120, backscattered primary light 218, and backscattered secondary light 220. Structure 234 may also enclose various components of assembly 200, in which case it may be understood as forming a “housing.” In some embodiments, structure 234 is also configured to reflect light such that a desired illumination pattern, such as a down light, flood light, etc., is emitted from assembly 200.

The thickness of the converters described herein, as well as the number, depth, shape, size and/or position/distribution of the apertures formed therein (including corresponding through holes, openings, passageways, cavities, etc.) may vary depending on the desired outcome. As will be discussed below, each of these parameters can impact the amount of unconverted primary light that passes through converter 104 and hence, the color point of light downstream of the converter. Moreover, these parameters may be controlled to obtain a desired degree of color uniformity, efficacy, and/or conversion efficiency. Thus, careful selection and/or control of these parameters may be desired.

The thickness of the converters described herein may vary over a wide range. For example, the converters described herein may have a thickness T ranging from about 25 to about 500 microns (μm), such as about 50 to about 400 μm, about 50 to about 300 μm, about 75 to about 225 μm, or even about 125 to about 225 μm. In some embodiments, a 125-225 μm thick converter is used.

Converter thickness may have an impact on the amount of primary light that passes unconverted through the converter. In some embodiments, for example, the amount of unconverted light passing through a converter may increase as the thickness of the converter decreases. Without wishing to be bound by theory, it is believed that reducing the thickness of the converter can decrease the path length of primary light in the converter. As a result, primary light entering a thin converter may have less opportunity (relative to a thick converter) to interact with the conversion material and be converted to secondary light. Conversely, thicker converters may increase the path length of primary light, thereby increasing the opportunity for the primary light to interact with the conversion material and be converted to secondary light.

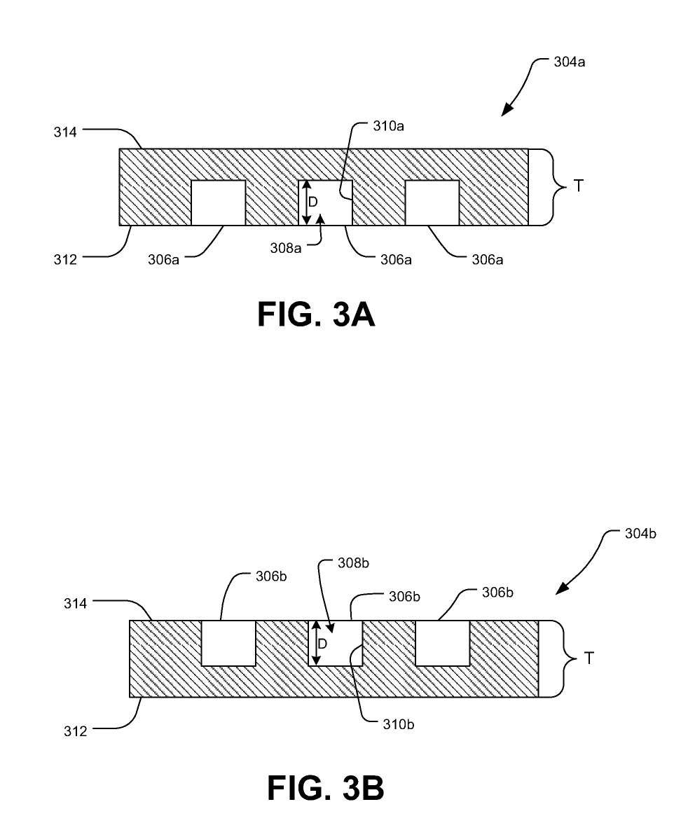

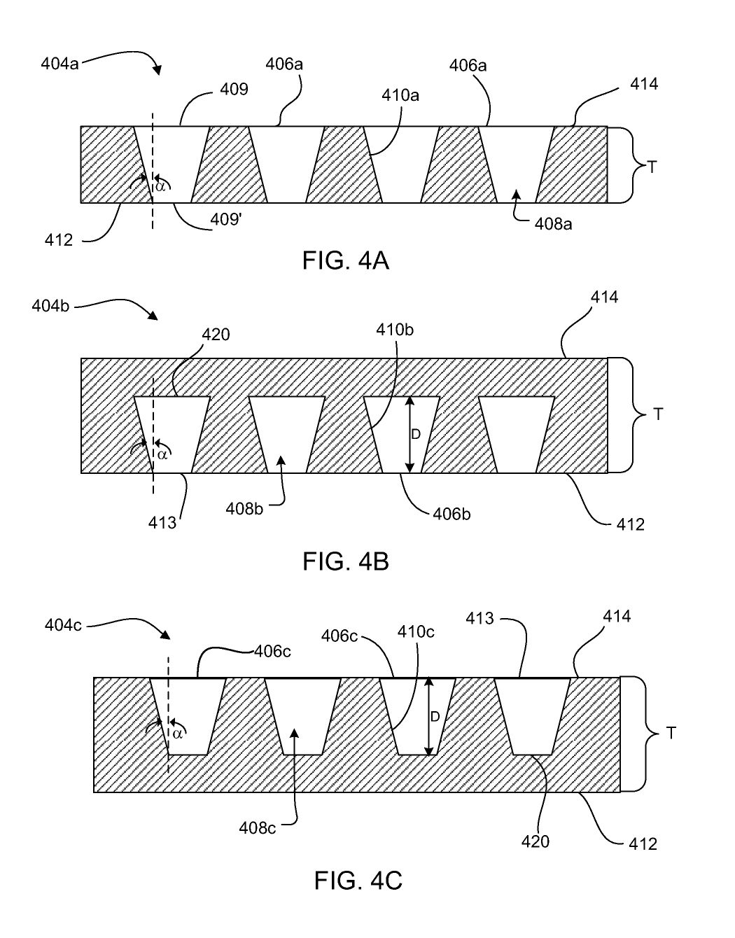

While a number of the FIGS. (e.g., FIGS. 1 and 2) depict a converter with a substantially uniform thickness, such a configuration is not required. Indeed as shown in FIGS. 3A, 3B, 4B, and 4C, converters 304a-b, and 404b-c include apertures 306a-b, 406b-c and corresponding holes 308a-b, 408b-c that define a plurality of cavities. The depth D of the cavities is less than the thickness T of the converter. As demonstrated by these examples, the thickness of the converters described herein may vary continuously, periodically, randomly, in a set pattern, and/or a combination thereof. In any case, the cavities may define regions within a converter that are relatively thin as compared to other, relatively thick regions. In such instances, the relatively thin regions of the converter may transmit more unconverted primary light than the relatively thick regions.

While variation in the thickness of a converter may coincide with cavities formed in the converter, such coincidence is not required. Indeed, the thickness of the converters described herein may vary independently of any cavities that may be formed therein.

The converters of the present disclosure may include any number of apertures. For example, converters consistent with the present disclosure may include 1, 2, 3, 4, 5, 6, 7, 8, 9, 10, 20, 30, 40, 50 or more apertures. In some embodiments, the converters described herein include from 1 to 20, 2 to 15, 3 to 12, 4 to 10, or even 5 to 8 apertures. As may be understood from the figures, such apertures 106 may be associated with corresponding structures, such as openings, passageways, cavities, and the like. Accordingly, such corresponding structures may be included in the converters of the present disclosure in amounts correlating to the values and ranges specified above with respect to the number of apertures.

The depth of the structures (i.e., openings, cavities, passageways, etc.) formed by the apertures described herein may vary considerably. When an aperture forms an opening, hole, or passageway through the converter, the depth of the aperture (and corresponding through hole) may be understood as being the same as the thickness of the converter at the aperture's location. This concept is generally illustrated in FIGS. 1, 2, and 4A, wherein apertures 106, 406a and corresponding through holes 108, 408a form passageways/openings that extend through the entire thickness (T) of converter 104, 404a.

When an aperture forms a cavity, the depth of the cavity may be somewhat less than the thickness of the converter at the aperture's location. This concept is shown in FIGS. 3A and 3B, wherein depth D of the cavities formed by apertures 306a-b and holes 308a-b is less than thickness T of converters 304a, 304b, respectively. Similarly, frustoconical cavities formed by apertures 406b, 406c and holes 408b, 408c in FIGS. 4B and 4C have a depth D that is less than the thickness T of converters 404b, 404c, respectively. In some embodiments, the apertures form one or more cavities having a depth ranging from about 1 to about 99%, such as from about 10 to about 90%, about 20 to about 80%, about 30 to about 60%, about 40 to about 50%, of even about 50% of the thickness of the converter in which they are present. Thus for example, if a converter has a thickness of 100 μm, one or more apertures and holes may define a cavity therein having a depth ranging from about 1 to 99 μm, about 20 to about 80 μm, about 30 to about 60 μm, about 40 to about 50 μm, or even about 50 μm.

When a converter consistent with the present disclosure includes one or more cavities, the converter may be oriented such that cavities are on a side that is proximal or distal to a source of primary light. In other words, the cavities may be formed in an upper or lower surface of a converter, where the terms “lower surface” and “upper surface” means the surfaces of the converter that are proximal and distal, respectively to a source of primary light. FIGS. 3A, 3B, 4B and 4C show this concept by illustrating cavities formed by apertures 306a-b, 406b-c and holes 308a-b, 408b-c as formed in lower surface 312, 412 and upper surface 314, 414 of converters 304a, 404b, 304b and 404c, respectively. Of course, the arrangement of cavities in these FIGS. is exemplary only, and other cavity arrangements are possible. For example, the converters described herein may include cavities on both their upper and lower surfaces.

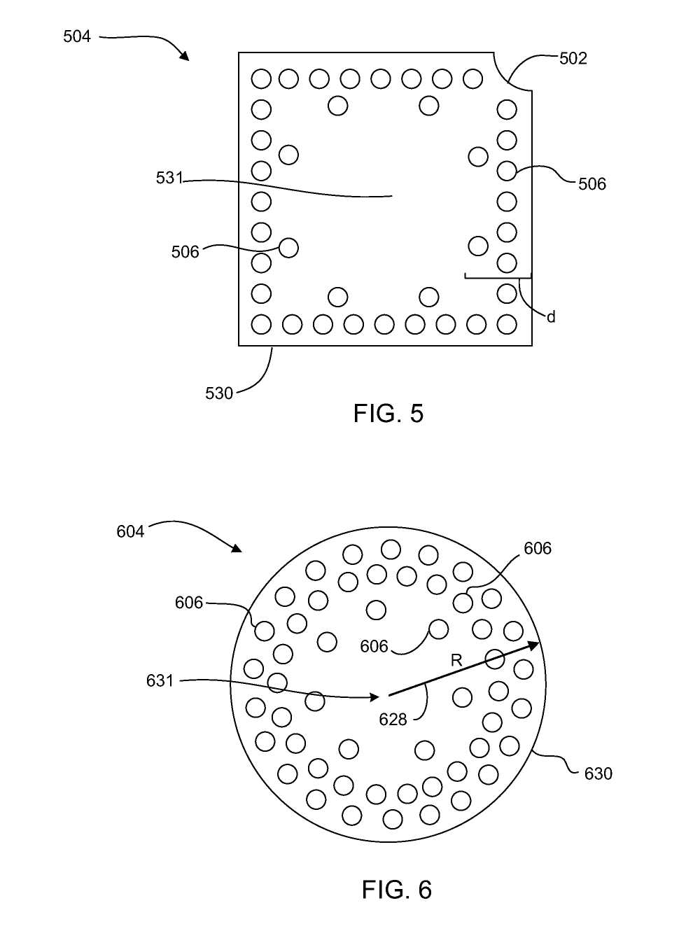

The shape and location of the apertures in the converter plate described herein may vary widely. For example, and as shown in FIGS. 5-8, the apertures may take the form of generally circular openings in an upper and/or lower surface of a converter. Alternatively or additionally, the apertures may be in the shape of an ellipse, an oval, a triangle, a quadrilateral (e.g., a square, a rectangle, etc.), a geometric shape having from about 5 to about 20 (or more) sides, an irregular opening, combinations thereof, and the like.

The cross sectional shape of a hole may be the same as or different from the shape of its corresponding aperture. In general, a through hole may be defined by one or more sidewalls that extend from one or more edges of an aperture. For example, a hole may include one or more sidewalls that extend substantially perpendicularly from an edge of an aperture. As shown in FIGS. 3A and 3B, for example, holes 308a-b each include sidewalls 310a-b that extend perpendicularly from an edge (not labeled) of a corresponding aperture 306a-b. Alternatively or additionally, the holes may include one or more sidewalls that extend at an angle from an edge of a corresponding aperture, as discussed below in connection with FIGS. 4A-4C.

While various figures depict the sidewalls of a hole as linearly extending from an edge of an aperture, such a configuration is not required. Indeed, the sidewalls of an aperture may extend in a curvilinear, irregular, jagged, saw tooth and/or other manner from an edge of an aperture. The cross section of the hole may therefore reflect the configuration of its sidewall(s).

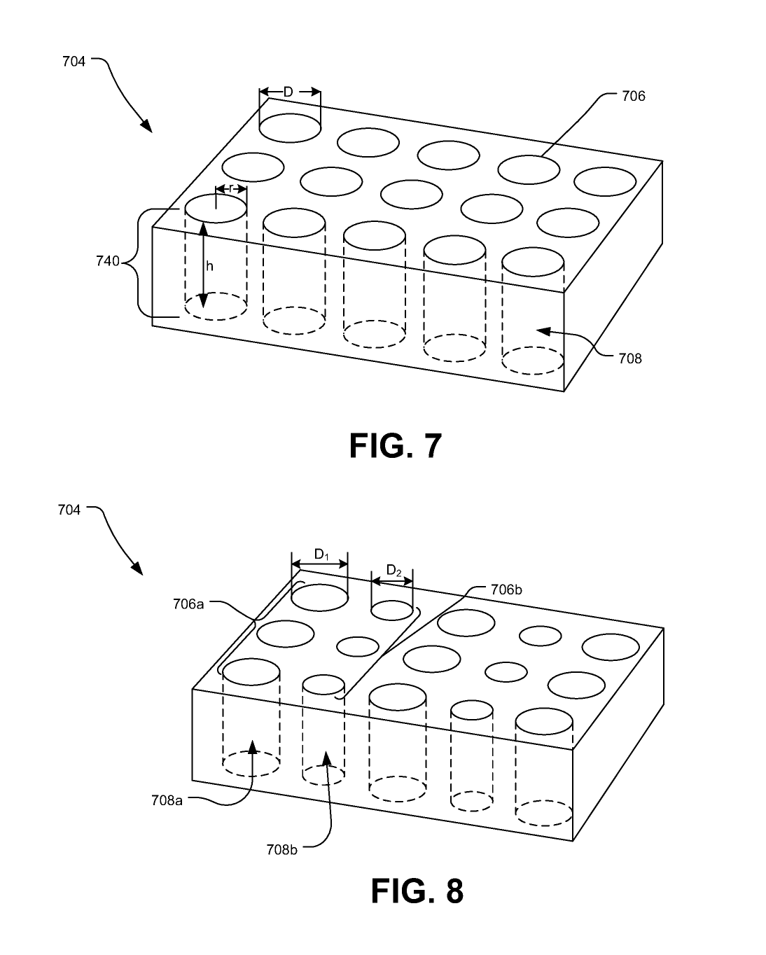

The openings, passageways, and/or cavities (individually and collectively, “structures”) formed by the apertures (and holes) described herein may have any suitable shape or configuration. In one embodiment, such structures may have a generally cylindrical shape, as in the case of cylindrical openings 740 in FIGS. 7 and 8. Alternatively or additionally, the apertures and holes may form structures having a generally frustoconical shape, as shown in FIGS. 4A to 4C. FIG. 4A depicts an embodiment wherein apertures 406a and through holes 408a define openings/passageways in converter 404a that include a top open end 409 and a bottom open end 409′. Sidewalls 410a extend at an angle α from an edge of bottom open end 409′ to connect the edges of top open end 409 and bottom open end 409′, thereby giving the openings/passageways formed by through holes 408a a frustoconical shape. Similarly, FIGS. 4B and 4C depict embodiments wherein apertures 406b-c and holes 408b-c define cavities within converters 404b-c that include an open end 413 and a cavity bottom 420. In FIG. 4B, sidewalls 410b extend at an angle α from an edge of open end 413 to connect the edges of open end 413 and cavity bottom 420. In FIG. 4C, sidewalls 410c extend at an angle α from an edge of cavity bottom 414 to connect the edges of cavity bottom 420 and open end 413. In either case, the cavities formed by apertures 406b-c and holes 408b-c have a frustoconical shape.

Angle α may range from about 1 to about 89°, such as about 10 to about 60°, about 20 to about 50°, about 30 to about 45°, or even about 35 to about 45°. In some embodiments, angle α ranges from about 25 to about 50°. Of course, such angles are exemplary only, and angle α may have any desired value. As may be understood by one skilled in the art, openings/cavities having a frustoconical shape may be able to reduce, minimize, or even prevent backscattering of primary and/or secondary light.

The dimensions of the apertures described herein (as well as corresponding holes and structures) may vary widely. In some embodiments, the apertures may have a long dimension ranging from 10-500 microns (μm), such as from about 20 to about 400 μm, about 25 to about 300 μm, about 35 to about 250 μm, about 50 to about 200 μm, or even about 50 to about 100 μm. In the context of an aperture, the term “long dimension” means the longest distance between two points of the aperture in question. In the case of circular apertures for example, the long dimension correlates to the diameter of the circle defined by the aperture. In the case of oval or ellipsoidal apertures, the long dimension correlates to the length of a line segment extending between two points on the aperture that are furthest apart from one another. Similarly, the term “long dimension” when used in the context of a passageway, opening, and/or cavity formed by an aperture and corresponding hole means the longest distance between two points of a cross section of the passageway, opening, and/or cavity at its widest point, unless otherwise specified herein.

Openings and/or passageways formed in a converter may include top and bottom open ends that may be defined by respective top and bottom apertures. Similarly, a cavity may be bounded by a single open end (defined by an aperture) and a cavity base, which is typically some portion of the converter. In any case, the long dimension of such extremities (e.g., the top open end, bottom open end, and/or cavity bottom) may be the same or different. In some embodiments, the long dimension of one extremity (e.g., the top open end) of a passageway/opening/cavity may differ from the long dimension of the other extremity (e.g., the bottom open end/cavity bottom) by 0 to about 50%, such as about 1 to about 50%, about 5 to about 30%, or even about 10 to about 25%. As implied by the inclusion of 0% in the foregoing ranges, the converters of the present disclosure may include one or more passageways/openings/cavities having extremities (e.g., top open end, bottom open end, and/or cavity bottom) that have identical long dimensions.

Many of the figures depict that one or more apertures and holes may form multiple openings, passageways, and/or cavities that are the same size. It should be understood that such configuration is exemplary only, and is not required. Indeed, the present disclosure envisions embodiments wherein apertures and/or holes of different dimensions are used to form corresponding openings, passageways, and/or cavities of different dimensions. This concept is illustrated in FIG. 8, wherein converter 704 includes a plurality of apertures 706a, 706b and corresponding through holes 708a, 708b. As shown apertures 706a have a long dimension (diameter D₁) that is different from the long dimension (diameter D₂) of apertures 706b. As through holes 708a and 708b are defined by sidewalls extending perpendicular from an edge of apertures 706a and 706b, their long dimensions also correlate to diameters D₁ and D₂, respectively.

The apertures (including corresponding holes/structures) may be distributed within a converter in any desired manner. For example, apertures may be distributed homogeneously, inhomogeneously, and/or randomly within a converter. Alternatively or additionally, apertures may be distributed in a converter in an ordered or semi-ordered array. Such ordered or semi-ordered array may form a pattern of openings, passageways, and/or cavities within the converter, and/or may localize apertures (and corresponding holes/structures) in a desired region of a converter. As a non-limiting example of this concept reference is again made to FIG. 8, wherein rows of apertures 706a and through holes 708a alternate with rows of apertures 706b and through holes 708b.

The distribution of the apertures (including their size and location) in the converter plate may also be described in terms of density, i.e., the number of apertures present in a given unit area of the converter. In some embodiments, the density of apertures (and their corresponding holes) may be uniform throughout the converter. In other embodiments, the density of apertures may increase or decrease from a point of origin, e.g., the center of the converter in question. Thus for example, the density of apertures near the center of a converter may be relatively low, whereas the density of apertures near an edge of the converter may be relatively high, and vice versa. In this regard, the density of apertures may increase or decrease linearly, exponentially, and/or logarithmically from the center of a converter. Alternatively or additionally, the apertures may be positioned within a desired region of a converter, e.g., within a certain distance of an edge or the center of the converter in question.

FIGS. 5 and 6 illustrate these concepts. FIG. 5 depicts converter 504, which has a substantially rectangular shape and includes notch 502 in one corner to allow for attachment to an LED or other structure, e.g., through wire bonding. Converter 504 also includes circular apertures 506. Apertures 506 and corresponding through holes (not shown) form openings that extend through the entire thickness of converter 504. In this case, apertures 506 are distributed near edge 530 of converter 504, whereas center portion 531 of converter 504 is devoid of apertures 506. In particular, apertures 506 are all distributed within a distance d relative to edge 530 of converter 504, wherein d is less than or equal to about 20%, 15, 10, 5, or even 1% of the longest or shortest dimension of the converter 504.

Placing apertures 506 (and corresponding through holes/structures) in this manner may reduce unwanted side emission from converter 504. For example, apertures 506 may break up internal wave guiding of primary or secondary light before such light can reach a side of converter 506 and be emitted from such side, rather than a top surface of converter 506. Such placement of apertures may also be used to control far field color mixing and color distribution properties in a desired way.

FIG. 6 depicts another exemplary configuration in which converter 604 is substantially circular and includes apertures 606. In this embodiment, the density of apertures 606 increases as a function of the radius R of converter 604, as generally shown by arrow 628. Thus, increasingly more apertures 606 (and corresponding through holes/structures) may be found as one progresses from center 631 to edge 630. Like the configuration shown in FIG. 5, this configuration may reduce side emission from converter 604, e.g., by breaking up internal wave guiding of primary or secondary light before such light may reach a side of converter 604 and be emitted from such side, rather than a top surface of converter 604.

By concentrating apertures near an edge of a converter, the converters of the present disclosure may improve the distribution of light emanating from the converter itself. In this regard, it is noted that conventional converters often produce light that does not have a uniform distribution. For example, a converter that produces yellow secondary light in response to stimulation from blue primary light may produce light that has a strong yellow spectral component nearer to an the edge of the converter. By concentrating apertures and through holes near an edge of a converter, high yellow emission may be balanced by allowing more unconverted blue primary light to pass through the converter at that edge. In other words, the converters of the present disclosure may be configured to balance localized high secondary light emission with increased amounts of unconverted primary light. In instances where additional conversion materials are placed at, in, or about the apertures (including corresponding through holes/structures), the converters may also balance high secondary light emission with the spectral components of light produced by such additional conversion materials.

In instances where a converter is used in a remote phosphor configuration, it should be understood that the converter is not attached to an LED, but rather to some other portion of the assembly containing the LED (e.g., a light package). In any case, the area of the converter in such a configuration may be substantially larger than the area of a converter used in a CLC configuration. Moreover, converters used in a remote phosphor configuration will typically be surrounded air (refractive index=1). This is in contrast to converters used in a CLC configuration, which are adhered to an LED with an adhesive (e.g., silicone with a refractive index of 1.4-1.53). As a result, the angle of total internal reflection is therefore smaller for light propagating in a converter in a remote phosphor configuration, as compared to that of a converter in a CLC configuration. This may cause stronger wave guiding in the remote phosphor configuration, and the long path lengths available in such configuration may result in absorption loss for primary and/or secondary light. The inclusion of one or more apertures (and corresponding holes/structures) may address this issue by reducing (e.g., breaking) wave guiding and providing increased opportunity for the light to be extracted from the converter before absorption, and/or before the light is emitted from a side of the converter.

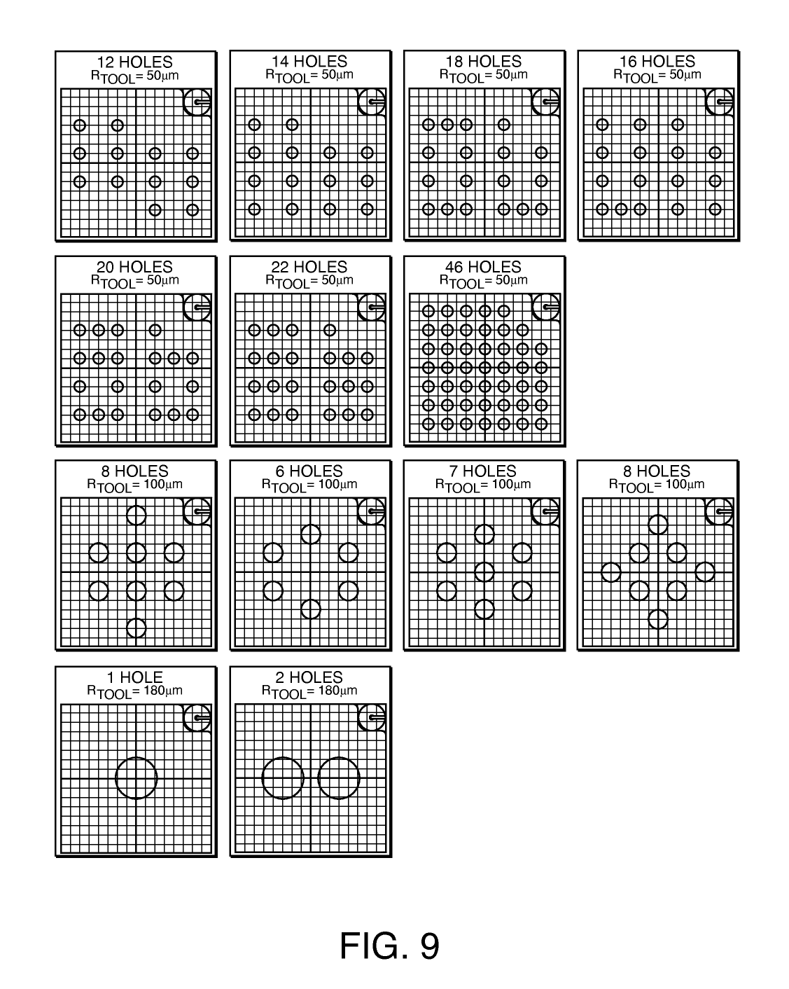

The apertures may be located in various positions and in various patterns, depending on the desired end result. In this regard, FIG. 9 shows various exemplary layouts for converters that include different size apertures. Each set of apertures is overlaid onto an image of an LED chip to show where the apertures of the converter would overlap the interconnects of an LED chip. Although not required, the grid pattern may be useful to facilitate the production of the apertures. Of course, these aperture configurations are exemplary only, and other layouts are possible and envisioned by the present disclosure.

Converters consistent with the present disclosure may be made by any suitable method. In instances where an all-ceramic converter is desired, for example, such converter may be manufactured by mixing one or more ceramic phosphor powders in a binder, thereby forming ceramic material in a green state. The green state ceramic may then be cast into a desired conformation, e.g., via injection molding or another technique. The casting may then be heated to pyrolize the binder and form a presintered ceramic. The presintered ceramic may then be sintered to substantially full density. Alternatively, sintering to full density may occur in one step, i.e., without the production of a presintered ceramic. In other embodiments, a converter may be formed by dispersing desired phosphor materials in a binder (e.g., optical quality silicone), and casting/curing the resulting mixture in a desired shape.

In any case, the apertures (and corresponding holes/structures) may be formed during or after the formation of the converter. In one embodiment, a converter consistent with the present disclosure may be made by a known molding or template method in which a phosphor silicone mixture is injected into a desired mold or template cell to produce a converter containing one or more apertures. Alternatively, apertures may be formed by subjecting a converter to a drilling process, a stamping process, an ablation process, an etching process, combinations thereof, and the like. Exemplary drilling processes that may be used include mechanical drilling, water drilling, and the like. Exemplary ablation processes that may be used include photo (e.g., laser) ablation and the like. Exemplary etching processes that may be used include chemical etching, photochemical etching, and the like.

In one non-limiting embodiment, apertures (and corresponding holes/structures) consistent with the present disclosure are formed by producing a ceramic converter in the green state, and subjecting the green state ceramic to one or more of the aforementioned processes. After forming the desired apertures, the green state ceramic was sintered to form a consolidated ceramic converter. The holes formed in the green state were appropriately sized to account for shrinkage that may occur during sintering.

As noted previously, prior art methods can adjust the color point of a converter containing a given ceramic phosphor composition (e.g., YAG: Ce or LuAG:Ce) by altering the converter's thickness and/or by changing the sintering temperature used to produce the converter. Such methods can cause a color point shift by reducing the emission of secondary (e.g., yellow) light from the converter, while increasing primary (e.g., blue) light emission/transmission. Since the emission/transmission of primary light is linked to the emission of secondary light, increasing primary light emission/transmission comes at the expense of reducing secondary light emission. In instances where the secondary light is nearer to the luminous efficacy peak at 555 nm than the primary light, the reduction in secondary (e.g., yellow) light can cause a corresponding reduction in the efficacy of the system. As described below, the converters of the present disclosure may address one or more of these issues through the use of the aforementioned apertures.

In this regard, the converters of the present disclosure may be configured to transmit or otherwise permit a controlled amount of unconverted primary light to pass there though. Unconverted primary light photons passing through the converter may contribute to the total spectrum of light that is present downstream of the converter, i.e., a region distal to the source of primary light. As the amount of unconverted primary light photons passing through the converter increases, the color point of the light downstream of the converter may be shifted or “steered” towards the color point of the unconverted primary light. Likewise, as the amount of unconverted primary light photons passing through converter decreases, the color point of light downstream of the converter may correspond more closely to the color point of the secondary light produced by the converter. This phenomenon is hereafter referred to as “color steering” for convenience.

By controlling various parameters of the apertures (and/or corresponding holes/structures), the converters of the present disclosure may be configured to transmit more unconverted primary light photons than would be transmitted by an otherwise identical converter that does not include apertures. More specifically, the converters of the present disclosure may include one or more apertures configured to increase the transmission of unconverted primary light photons by greater than or equal to about 0.1%, 0.5%, 1%, 2%, 3%, 4%, 5%, 6%, 7%, 8%, 9%, 10%, 11%, 12%, 15%, 20%, or even 25%, relative to an identical converter that does not include any apertures. In one non-limiting embodiment, a converter in accordance with the present disclosure includes one or more apertures and/or holes that are configured to allow 10-12% more unconverted primary light photons to pass through the converter, relative to an identical converter that does not include apertures.

Increased passage of unconverted primary light may also be understood in terms of the percentage increase in the optical power of primary light downstream of the converter, relative to the optical power of primary light downstream of an otherwise identical converter that does not include apertures. In some embodiments, light downstream of the converters described herein may have a primary light optical power that is greater than or equal to about 1, 10, 20, 50, 100, 500, 1000, 1500, 2000, 3000, 3800, or even about 4000 percent higher than the optical power of primary light downstream of an otherwise identical converter that does not include any apertures.

An increase in unconverted primary light photons may result in a corresponding shift in the color point of light downstream of the converters described herein. For example, where the primary light used is blue light, an increase in the number of unconverted blue primary light photons may shift the color point of the light downstream of the converter towards the wavelength of the blue primary light, i.e., along the conversion line.

The apertures described herein may also provide a convenient opportunity to leverage additional conversion materials, e.g., to further refine the light spectrum downstream of the converter. For example, one or more additional conversion materials (or blend of conversion materials) may be used to fill all or a portion of the apertures (and/or corresponding holes/structures) in the converter. In some embodiments, all or a portion of the apertures of the converter are filled with a second conversion material (or blend of conversion materials). In other non-limiting embodiments, second and third conversion materials (or second and third blends of conversion materials) are used to fill all or a portion of the apertures in the converter. Alternatively or additionally, one or more layers of additional conversion material(s) may be placed on top or bottom of a converter, e.g., so as to overlie all or a portion of the apertures formed therein. When used, such layer(s) may be formed on the top or bottom of the converter (i.e., on a side distal or proximal to the source of primary light).

In any case, the additional conversion materials may contribute to the total spectrum of light downstream of the converter by converting incident primary light to light with a wavelength other than the secondary light produced by the first conversion material(s) used to make up the bulk of the converter. As such, use of the additional conversion materials may allow color steering in a region of the spectrum other than the conversion line of the first conversion material(s). In instances where the light produced by the additional conversion material(s) is more luminous than the primary light, the efficacy of the light emitted by the converter may be increased. Moreover, such additional conversion materials can be used to adjust the color rendering index (CRI) to a desired value, by additional spectral components to light downstream of the converter. In some embodiments, use of additional conversion materials can result in a converter having a CRI that is greater than or equal to about 90, such as about 91, 92, 93, 94, 95, 96, 97, 98, 99, or even 100, relative to a reference light source. The additional conversion materials may also be used to adjust the color temperature of light downstream of the converter. For example, red phosphor conversion materials may be used to add additional red light, thereby “warming” up the color temperature of the light downstream of the converter.

In any case, the additional conversion materials may be chosen from the phosphor materials previously identified as being suitable for use in a converter. As a practical matter, however, the additional phosphor(s) may be different from the phosphor/conversion material(s) used within or to form the converter body itself.

In one non-limiting embodiment, a ceramic converter may be formed using a ceramic phosphor, e.g., YAG:Ce, which may produce yellow light in response to excitation by blue primary light. The converter included one or more apertures. An additional phosphor material (e.g., a red or green phosphor) may be placed in the apertures (e.g., as a phosphor powder in a host material such as silicone).

By adding the additional phosphor material, the color point of the light downstream of the converter could be shifted away from the wavelength of the yellow light produced by the YAG:Ce and towards the wavelength of the light produced by the red and/or green phosphor. To the extent additional unconverted blue primary light may pass through the converter, the color point of the light downstream of the converter may also be steered towards the wavelength of the blue primary light.

The apertures described herein may also be configured to increase unconverted primary light transmission while maintaining or increasing the total emitting surface area of the converter. In this regard, it is noted that the emitting surface area of a conventional converter is often limited to the sides and top of the converter itself. By including one or more apertures, the converters of the present disclosure have an emitting surface area that is reduced by the surface area removed by the apertures. However, the emitting surface area is increased by the lateral surface area of the apertures, i.e., the surface area of the holes and/or other structures formed by the converter. Thus, the amount of emitting surface area of the converters described herein relative to a conventional converter may be calculated using the following equation:

DESA (%)=[(SA_{c}−SAᵣ+SA₁)/SA_{c}]*100%

where DESA is the difference in emitting surface area, SA_{c} is the surface area of the converter without apertures), SAᵣ is the amount of surface area removed by the apertures, and SA₁ is lateral surface area of the apertures. Thus, DESA is 0 or positive if SA₁ is greater than or equal to SAᵣ.

To illustrate this concept, reference is again made to FIG. 7, which depicts a rectangular converter 704 that includes apertures 706 and through holes 708 defining cylindrical openings/passageways 740. For the sake of illustration, it is assumed that converter 704 is used in a CLC configuration, with only its top surface left exposed to emit secondary light. In this context, SA_{c} correlates to the area of the top surface of converter 704, which may be calculated using the formula SA_{c}=lw, where l and w correspond to the length and width of the top surface of converter 704. Of course, in instances where side or other emission is present, the surface area of the converter corresponding to such emission may also be accounted for in the calculation of SA_{c}

Thus in this example, the emitting surface area of converter 704 is maintained or increased (i.e., DESA is 0 or positive) if apertures 706 and through holes 708 are configured such that 2πrh≧2πr², i.e., such that the height (h) of cylindrical opening/passageway 740 is greater than or equal to the radius of aperture 706. As may be appreciated, the height h in this embodiment may be controlled by adjusting the thickness of converter 704, with increasing thickness resulting in increasing emitting surface area. Of course, if other portions (e.g., the sides) of converter 704 are exposed to emit secondary light, the calculation of SA_{c} should be adjusted appropriately. For example, if secondary light is emitted from the sides of converter 704, SA_{c} may additionally include the area of such sides, which may be approximately calculated using the formula SA_{cs}=(2l+2w)*h, wherein SA_{cs} is the surface area of the sides, and l, w, and h are the length, width and height of the sides, respectively. SAᵣ correlates to the area of aperture 706, i.e., the top of cylindrical openings/passageways 740. As apertures 706 are circular, SAᵣ=2πr², where r is the radius of the apertures 706. SA₁ correlates to area of the inner surface of cylindrical openings/passageways 740 and thus may be calculated using the formula SA₁=2πrh, where r and h are the radius and height of cylindrical openings/passageways 740, respectively.

In some embodiments, the converters of the present disclosure are configured such that they exhibit a DESA greater than or equal to about 0, 5, 10, 20, 30, 40, 50, 60, 70, 80, 90, or even 95%. For example, the converters of the present disclosure may be configured to exhibit a DESA ranging from 0 to about 95%, about 5 to about 90%, about 10 to about 80%, about 20 to about 70%, about 30 to about 60%, or even about 40 to about 50%.

By maintaining or increasing the total emitting surface area, the converters described herein may be configured to emit substantially the same amount of secondary light as an otherwise identical converter that does not include any apertures. In this context, the term “substantially the same amount of secondary light” means that a converter in accordance with the present disclosure may produce greater than or equal to about 95% of the secondary light that would be produced by an otherwise identical converter that does not include apertures. In some embodiments, the converters of the present disclosure may emit greater than or equal to about 96, 97, 98, 99, or even 100% of the secondary light that would be emitted by an otherwise identical converter that does not include apertures.

In still further embodiments, the converters of the present disclosure may be configured to increase transmission of primary light while emitting substantially the same amount of secondary light as an otherwise identical converter that does not include any apertures. Thus for example, the converters described herein may increase the transmission of unconverted primary light photons by the aforementioned amounts, while emitting greater than or equal to about 95, 96, 97, 98, 99, or even 100% of the secondary light that would be emitted by an otherwise identical converter without apertures.

From the foregoing, it may be understood that the converters of the present disclosure may exhibit improved conversion efficiency, relative to otherwise identical converters that do not include any apertures. As used herein, the term “conversion efficiency” means the ratio of the optical power of converted (e.g., secondary) light produced by a converter, relative to the optical power of primary light that is absorbed by such converter. Conversion efficiency may therefore be calculated using the following equation:

CE=(C/B_{abs})*100%

where CE is conversion efficiency, C is the optical power of the converted light emitted by the converter, and B_{abs} is the optical power of the primary light absorbed by the converter.

In some embodiments, the converters of the present disclosure may exhibit a conversion efficiency that ranges from greater than or equal to about 1, 5, 10, 15, 20, or even 25% higher than the conversion efficiency of an otherwise identical converter that does not include any apertures. In one non-limiting embodiment, the converters of the present disclosure exhibit a conversion efficiency that is about 1 to 10%, such as about 2 to 8% greater than the optical efficiency of an otherwise identical converter without any apertures. Without wishing to be bound by theory, it is believed that the increased optical efficiency of the converters of the present disclosure may be the result of improved secondary light extraction. More specifically, it is believed that the presence of apertures in the converters of the present disclosure can limit wave guiding within the converter, thereby reducing the amount of secondary light lost due to absorption.

### EXAMPLES

### Group 1: 70 μm, 105 μm, and 140 μm Converter Platelets Containing 1, 2, 6, 7, or 8 Holes

In a first group of samples, converter platelets a containing yellow phosphor (YAG activated with 2% Ce) as a conversion material were manufactured in three thicknesses (70, 105, and 140 μm). To produce the samples, green ceramic converter platelets were made by forming a mixture of yellow phosphor and binder into a desired conformation. Holes with a desired geometry and distribution were then formed in the green ceramic converter platelets. The platelets were then sintered to substantially full density. These resulting converter samples included either 1 or 2 holes with a nominal radius of 180 μm (149 μm post sintering), or six, seven, or eight holes with a nominal radius of 100 μm (84 μm after sintering).

For the purpose of comparison, control samples were also formed. The control samples were identical in thickness and composition as the converter samples, but did not include any holes. In this first batch of samples, the control samples are identified in the FIGS by the three letter abbreviation for standard, i.e., “STD.” In contrast, the converter samples are identified in the FIGS using a five letter suffix that reveals the number and nominal radius of the holes formed in the sample. The thickness of the control samples and converter samples in this batch is identified by a two letter prefix, e.g., 1b, 1c, 1d, wherein 1b correlates to a 70 μm thick sample, 1c correlates to a 105 μm thick sample, and 1d correlates to a 140 μm thick sample. Thus, a sample identified as 1b-6R100 is a 70 μm thick converter sample containing six holes having a nominal radius of 100 μm (84 μm post sintering). Likewise, a sample identified as 1d-STD is a 140 μm thick control sample.

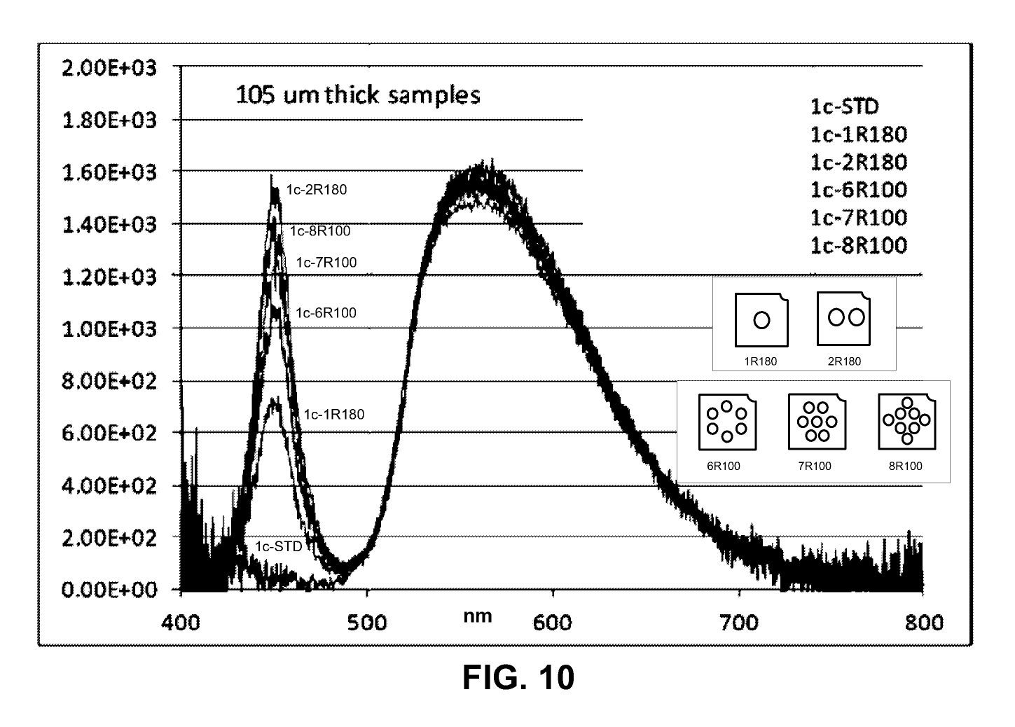

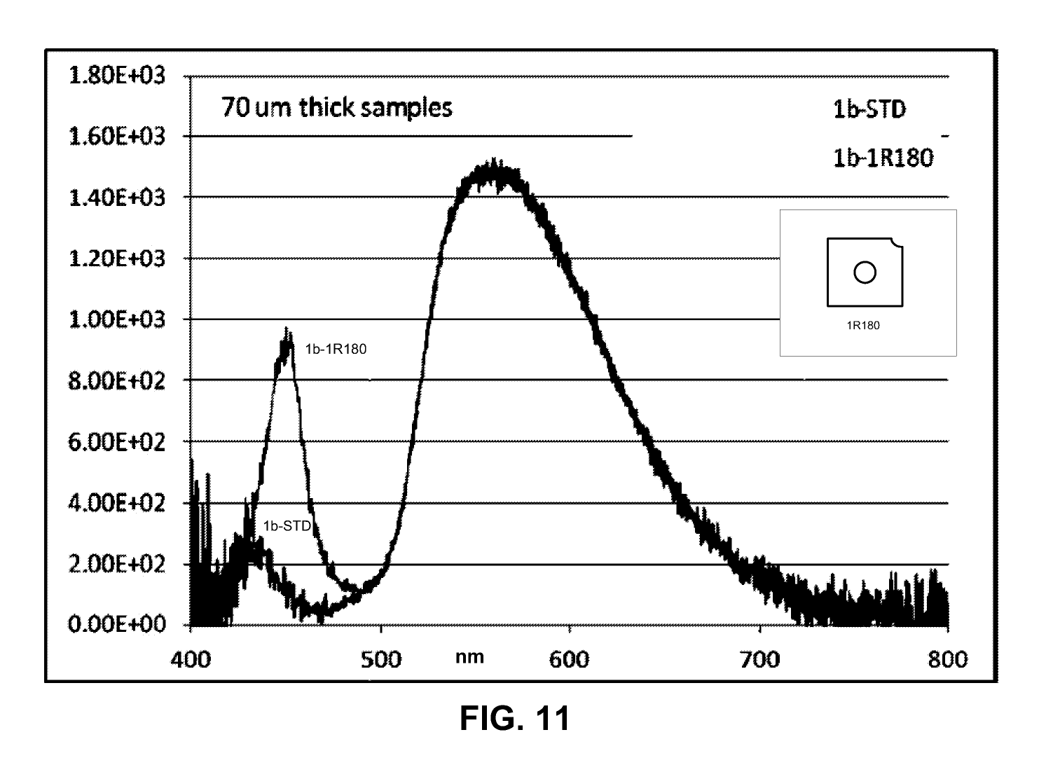

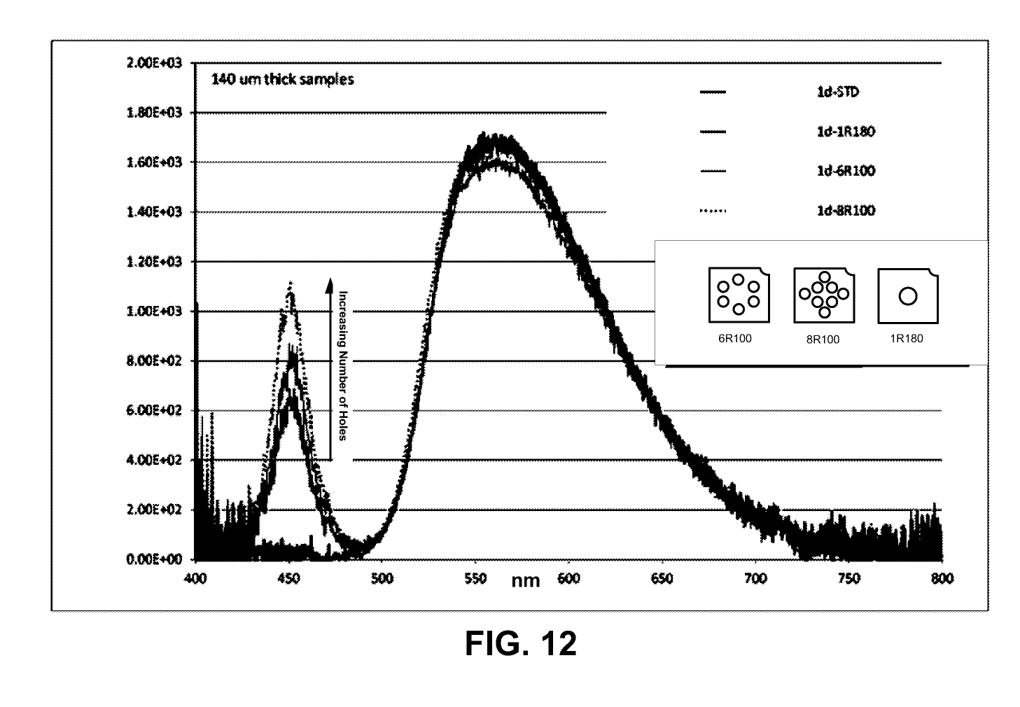

The control samples and converter samples were each mounted on a blue LED (InGaN emitting blue light in the 420-470 nm range) in a CLC configuration, and the spectra of light downstream of such samples was measured in an integrated sphere. Spectra measured from the 105 μm thick (1c), 70 μm thick (1b), and 140 μm (1d) thick samples are provided in FIGS. 10, 11, and 12, respectively. As shown, converter samples of a given thickness exhibited substantially the same yellow emission as their corresponding control sample, despite containing 1, 2, 6, 7, or even 8 holes. At the same time, an increase in the height of the blue peak was observed in the spectra measured from the converter samples, relative to the height of the blue peak of their corresponding control sample. The increase in blue peak height generally correlated to a blue shift observed in the light downstream of the converter samples.

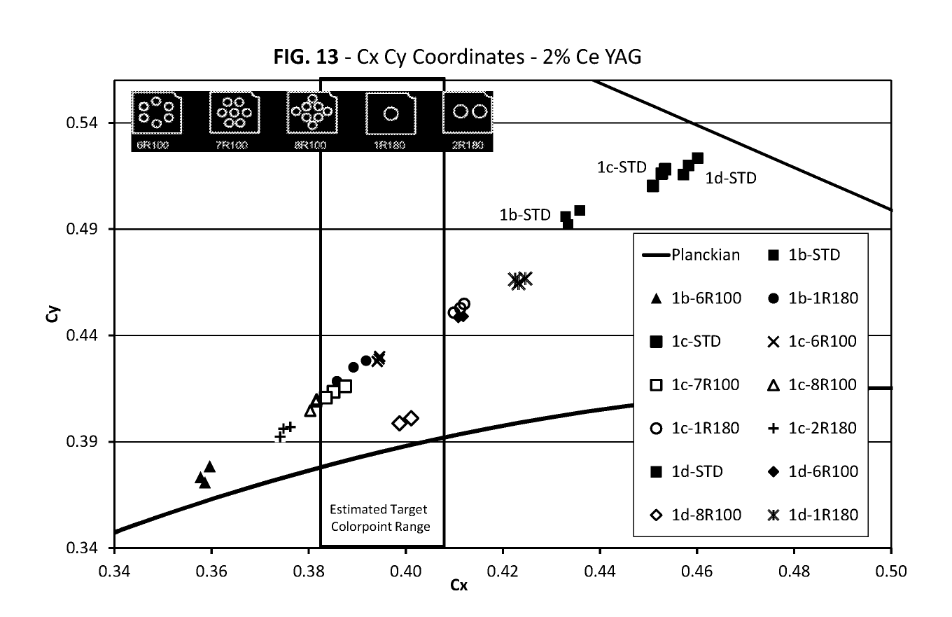

FIG. 13 plots color coordinate data that was measured from the converter samples and control samples described above. As shown, the value of Cx (a 1931 CIE coordinate) increased as thickness increased and/or the number of holes decreased. One of ordinary skill in the art may understand this as demonstrating that more yellow light was produced by thicker samples containing fewer holes than was produced by thinner samples containing more holes.

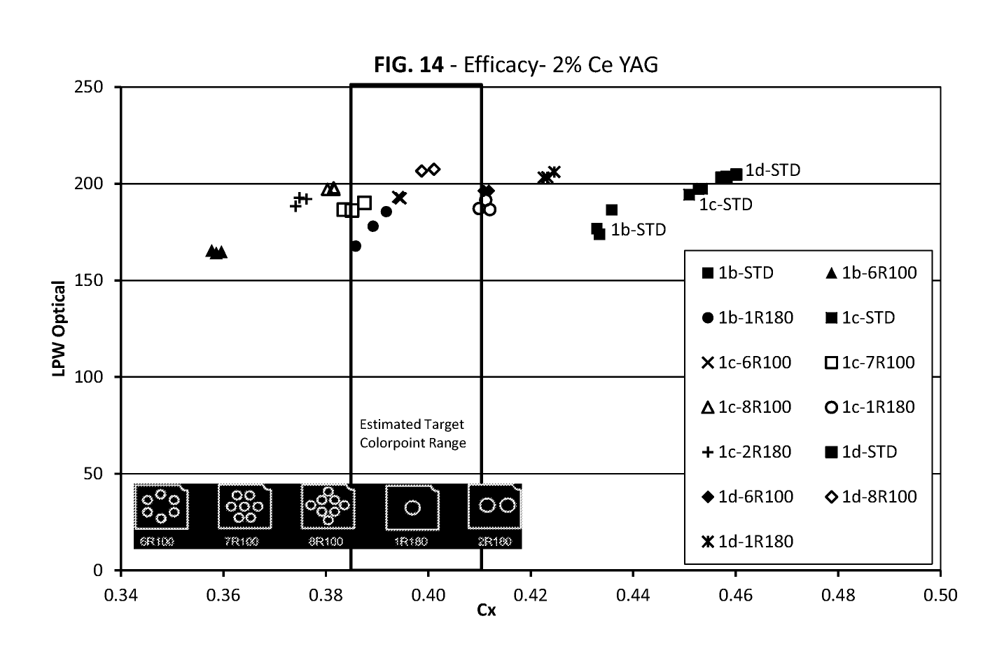

FIG. 14 plots efficacy data that was measured from the converter samples and control samples described above. As shown, sample converters containing 1 or more holes were able to approach, maintain or exceed the lumen output of a corresponding control sample. For example, sample 1d-8R100 (a 140 μm thick converter sample containing 8 holes with a nominal radius of 100 μm) produced light within a desired color point range (Cx˜0.39-0.41) and with a luminous efficacy that was substantially the same as the efficacy of sample 1d-STD (a 140 μm-thick control sample containing no holes).

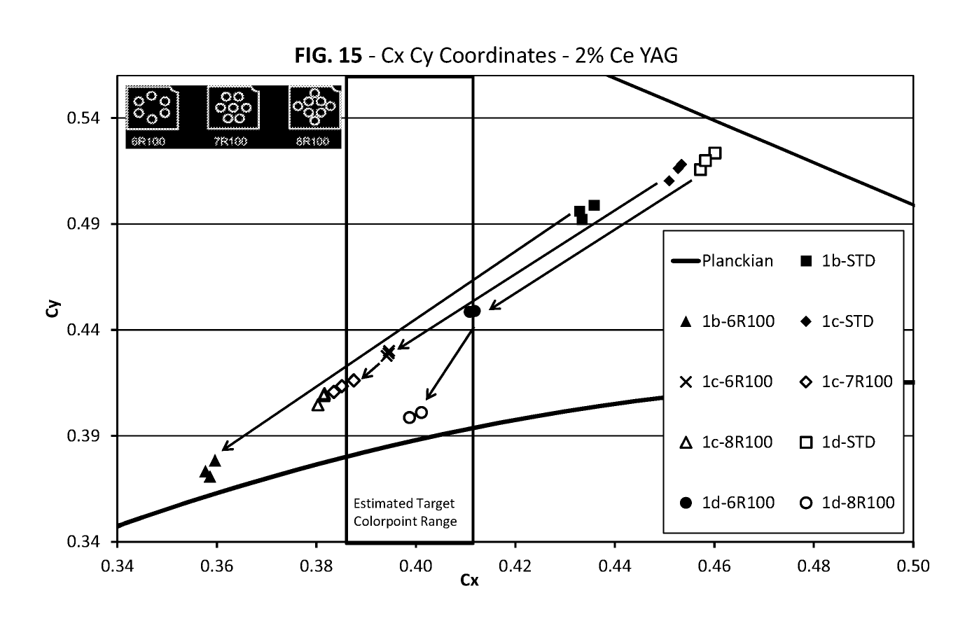

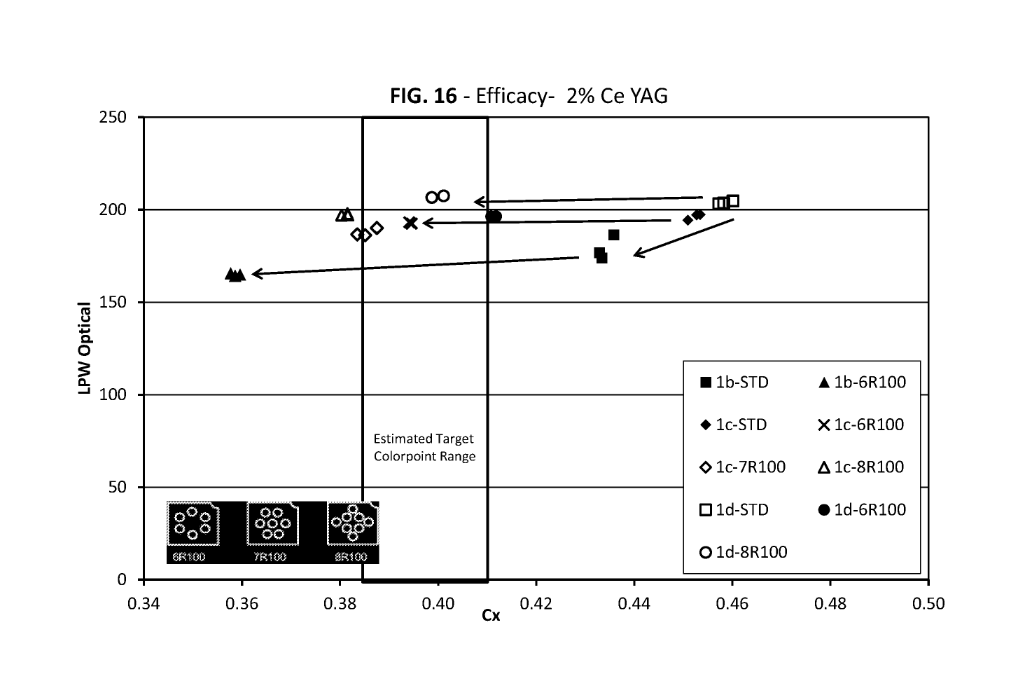

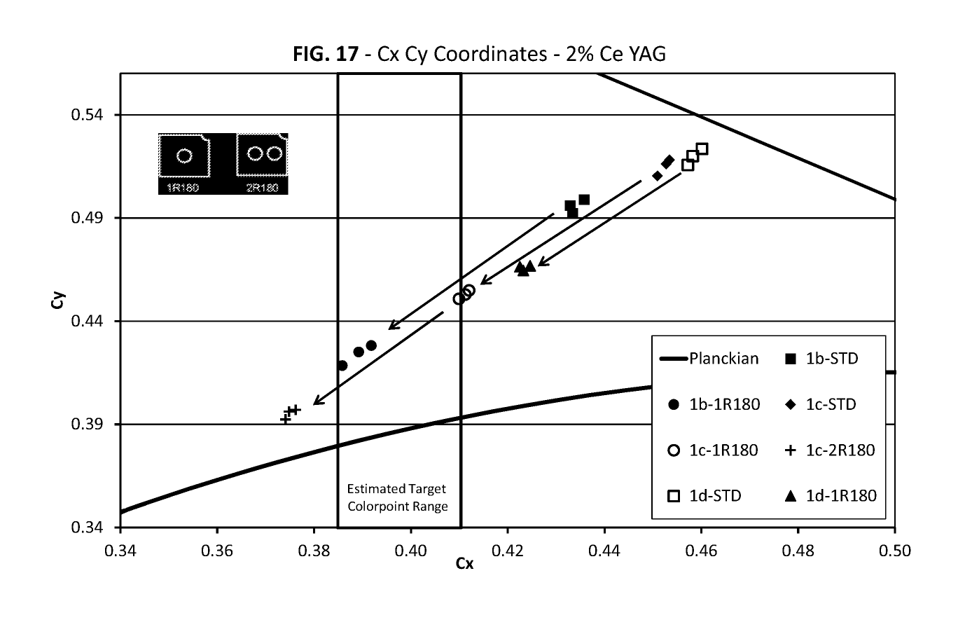

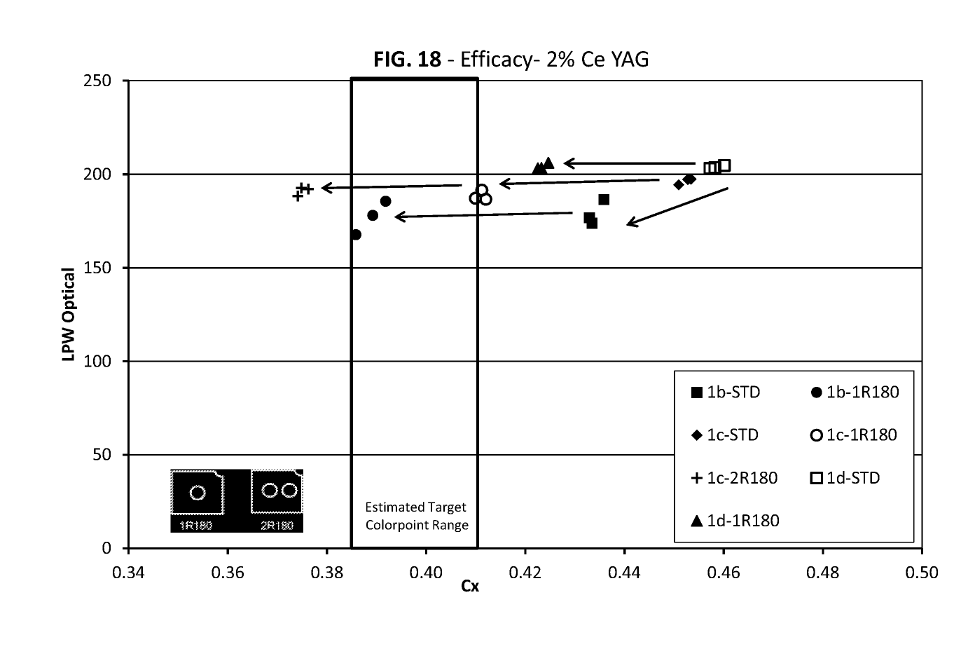

FIGS. 15-18 plot subsets of the data presented in FIGS. 13 and 14, according to nominal hole radius. The arrows in each of these FIGS. highlight the shift in the color point for each when holes are introduced into the measured platelets.

Efficacy data obtained from the 105 μm thick converter samples was further analyzed to determine the impact of hole related parameters on the spectra measured from such samples in an integrated sphere. The data is presented in Table 1 below. It is noted that slight variations in the data may arise due to the selection of the exact location of spectral integration boundaries used in the measurement. As demonstrated in Table 1, adding holes caused the power of incident blue primary light (Binc, (W)) that is transmitted (denoted Bthru, (W)) through the converters to increase, while the amount of blue light absorbed by the converter (Babs) dropped (Babs=Binc−Bthru). The light Conversion Efficiency (CE, as defined above as equal to C/Babs) is thereby increased. Similar trends were obtained for 70 and 140 μm thick converters. As further demonstrated by the Table 1, luminous efficacy of the spectra (LE) decreased with increasing total hole area due to the enhanced blue component (about 4-10%) in the spectra. LPWopt (lumens of converted light per incident blue power Binc) only fluctuates slightly depending on the lumen value of the converted light as Binc remained constant. If LPWopt were calculated relative to Babs, an increase (not shown) would be registered, similar to the increase in C/Babs. This suggests that an absolute efficacy increase (relative to Binc and a converter containing no holes) may be realized by optimizing the thickness of the converter, as well as the size and positioning of one or more holes formed therein.

Table 1 also shows that Bthru increased in correlation with the cross sectional area (CSA) of the holes as a fraction of the platelet area (including the rectangular sides) grows. Specifically, Bthru increased by 1.5-11.9% for samples containing 1-8 holes having a radius of 84 μm (post sintering) and by 4.7-9.4% for samples containing 1 or 2 holes having a radius of 149 μm (again, post sintering). Despite removing significant (e.g., up to 9.6%) amounts of blue primary light from the conversion process, the amount of secondary light produced by the converter remained nearly constant or increased. It is hypothesized that this maintenance is due to better light extraction, which may be facilitated by additional emitting surface area provided by the lateral area of the holes, as well as breaking of Total Internal Reflection (TIR) in locations/directions where such breakage was not previously possible. Table 1 also shows that adding up to eight 84 μm holes produced a net increase in emitting surface area of about 2.2-17.9% (including the rectangular sides and excluding the hole cross sections). Similarly, adding one or two holes with a radius of 149 μm produced a net increase in emitter surface area of about 1.3 to about 3.8%. This suggests that hole diameter and platelet thickness may have mutually related optima for the best light output around the tested thickness values of 140 μm and 105μm, respectively, possibly due to removed shadowing effects.

TABLE 1
Analysis of changing emission parameters from LED packages
using different 105 μm thick converters with holes.

| | Sintered | | | | | | | | | |
|---|---|---|---|---|---|---|---|---|---|---|
| Holes | Radius | CSA | % PA | LAH | NIEA | C/BAbs | Bthru | C/BInc | lm | LE |
| # | μm | μm² | % | μm² | % | % | % | % | (spectra) | lm/W |
| 0 | 0 | 0 | 0 | 0 | 0.0% | 63.7 | 0.5 | 63.4 | 87 | 457 |
| | Small | | | | | | | | | |
| 1 | 84 | 22166.424 | 1.5% | 55416.1 | 2.2% | | | | | |
| 6 | 84 | 132998.54 | 8.9% | 332496.4 | 13.4% | 66.6 | 6.9 | 62.1 | 85 | 401 |
| 7 | 84 | 155164.97 | 10.4% | 387912.4 | 15.6% | 65.5 | 8.0 | 60.3 | 82 | 392 |
| 8 | 84 | 177331.39 | 11.9% | 443328.5 | 17.9% | 69.2 | 8.7 | 63.2 | 87 | 391 |
| | Large | | | | | | | | | |
| 1 | 149 | 69744.442 | 4.7% | 98297.5 | 1.9% | 63.6 | 4.6 | 60.6 | 83 | 420 |
| 2 | 149 | 139488.88 | 9.4% | 196595.1 | 3.8% | 68.3 | 9.6 | 61.7 | 84 | 381 |

CSA—Cross sectional area of holes; % PA—CSA as a percentage of converter platelet area (%); LAH—lateral area of holes; NIEA—net increase in emitter area (%); C/BAbs—conversion efficiency per blue power absorbed (Babs); Bthru—fraction of incident blue light that is transmitted; C/BInc—conversion efficiency per incident blue power; lm (spectra)—converted lumens from spectra; LE—luminous efficacy of spectra;

### Group 2: 75 μm, 150 μm, and 225 μm Converter Platelets Containing 0-20 Holes—Measurements and Modeling

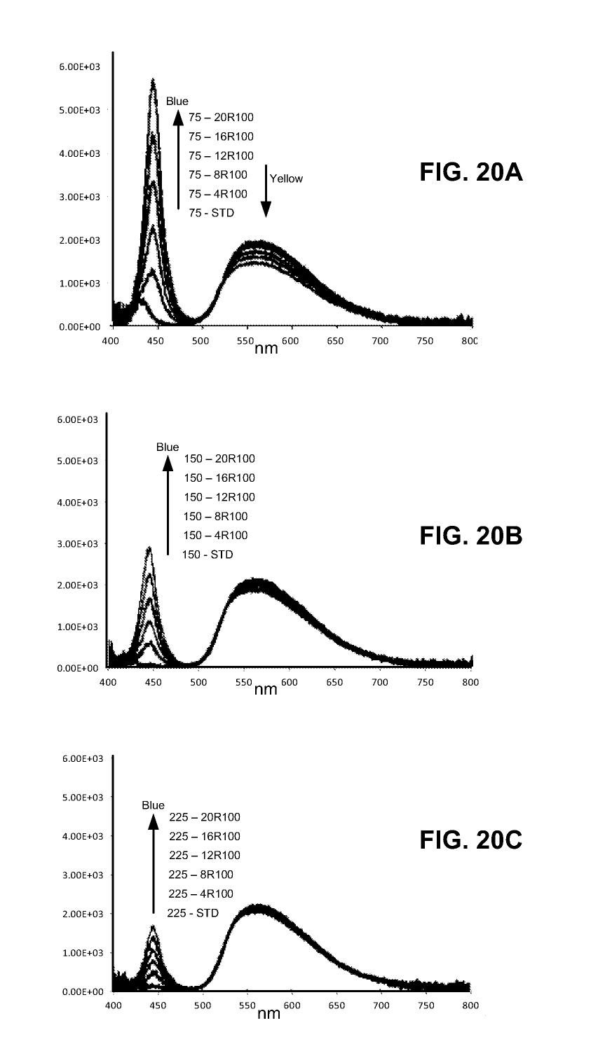

To further investigate the impact of converter thickness and hole related parameters (e.g., diameter, number, distribution, etc.) on optical performance, a second group of converter samples and control samples was produced. This group was produced in substantially the same manner as Group 1 described above, but was produced at different thicknesses and with different hole configurations. Specifically, samples were produced with thicknesses of, 75 μm, 150 μm, and 225 μm, respectively. The control samples included no holes, whereas the test samples included 4, 8, 12, 16, or 20 circular holes having a radius of 85 μm (post sintering). In FIGS. 20A-C, the measured samples are identified using a two or three letter prefix designating thickness and a three or five letter suffix designating the sample type, number of holes, and hole radius. Prefixes 75, 150, 225 correlate to samples that are 75 μm, 150 μm, or 225 μm thick, respectively. The suffix “STD” designates a control sample. Suffixes such as 4R100, 8R100, etc. denote converter samples, in this case converters containing 4 and 8 holes with a nominal radius of 100 μm (85 μm post sintering), respectively.

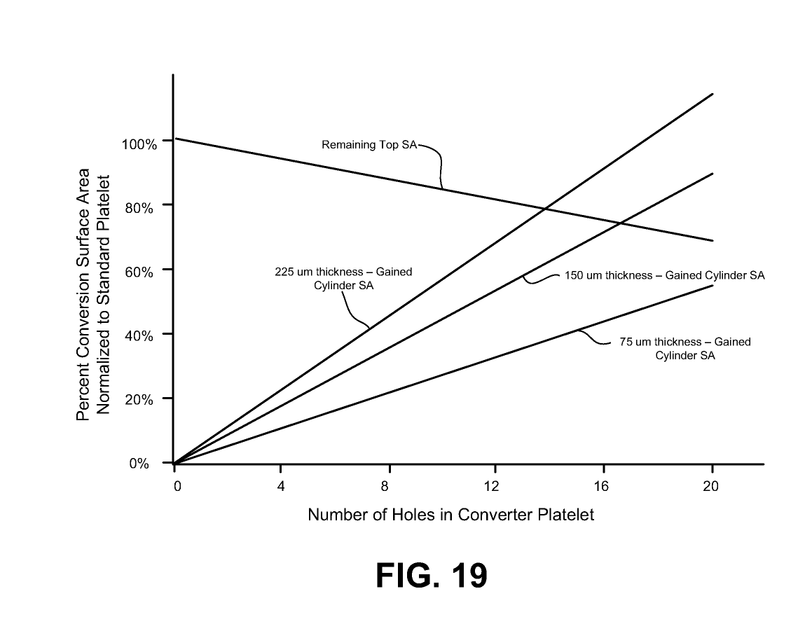

FIG. 19 plots the calculated net increase in emitting surface area of the converter samples vs. the number of holes (r=85 μm) in such samples. For the purpose of comparison, the data for each thickness was normalized to the surface area of a corresponding control sample. Relative to the control samples, the converter samples exhibited a net increase in emitting surface area ranging from 0% to 92%, with thicker samples containing more holes having a larger net increase in emitting surface area than thinner samples containing fewer holes. FIG. 19 also plots the calculated remaining top surface area of the control samples and converter samples. As shown, adding 4 to 20 holes (r=85 μm) reduced the top surface area of the sample converters by about 5 to about 30%. In many cases, however, the calculated additional surface area provided by the lateral surface of the cylindrical holes matched or exceeded the calculated reduction in top surface area. This is reflected by the fact that the calculated net increase in emitting surface area exceeded the calculated reduction in top surface area.

The spectra of each control and converter sample having 0-20 holes (r=85 μm) was measured in an integrated sphere. FIGS. 20A, 20B, and 20C, plot the spectra of the 75 μm samples, 150 μm samples, and 225 μm samples, respectively. In each case, the intensity of the blue peak increased as the number of holes increased. As shown in FIG. 20A, a decrease in the yellow peak in the spectra of the 75 μm samples was observed as the number of holes increased from 0 to 20. In contrast, little or no change in the height of the yellow peak in the spectra of the 150 μm and 225 μm samples was observed, regardless of the number of holes. Of note is the fact that each converter sample produced spectra having significantly increased blue peak height, relative to the blue peak height of corresponding control samples. A slight yellow shift in the blue peak of the 75 μm converter samples was also observed.

The samples of this batch were further measured to determine various other properties, such as their Cx value, lumens per watt of blue light (LPW opt blue), quantum efficiency (QE) of conversion on a photon to photon basis (hereafter, “conversion QE”), and various optical power values. The measured data was plotted in various ways to examine the impact of thickness and number of holes on optical performance. It is noted that the samples in this batch were measured using a blue primary light source (e.g., an InGaN LED) and included conversion material (YAG: Ce) that produces yellow secondary light when stimulated by such primary light

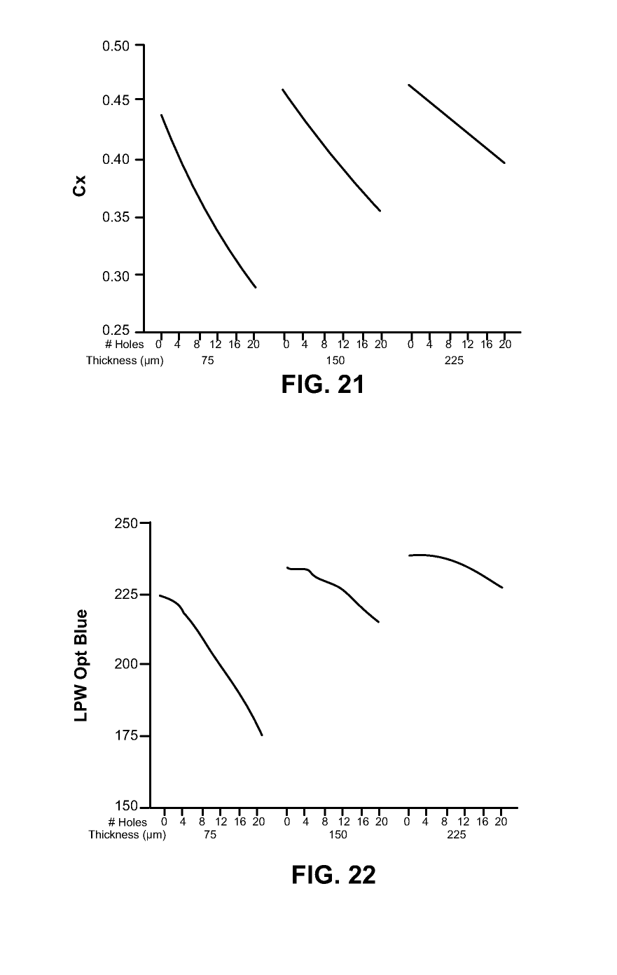

FIG. 21 plots Cx values vs. thickness and number of holes, based on data measured from the samples in this batch. As shown, Cx value (indicative of the amount of yellow light in the spectra) tended to increase as thickness increased and/or the number of holes decreased. This is consistent with hypotheses that thicker samples containing less holes will produce more secondary light during the conversion process. Increasing the number of holes from 0 to 20 produced the largest decrease in Cx in the 75 μm data, whereas the smallest decrease in Cx was observed in the 225 μm data.

FIG. 22 plots LPW opt blue vs. thickness and number of holes, based on data measured from the samples in this batch. As shown, LPW opt blue tended to increase as thickness increased and/or the number of holes decreased. This correlates to the increases in Cx value observed in FIG. 21, as yellow light is more luminous than blue light. As with the Cx value, increasing the number of holes from 0-20 produced the largest decrease in LPWopt blue in the 75 μm data, whereas the smallest decrease in LPWopt blue was observed in the 225 μm data.

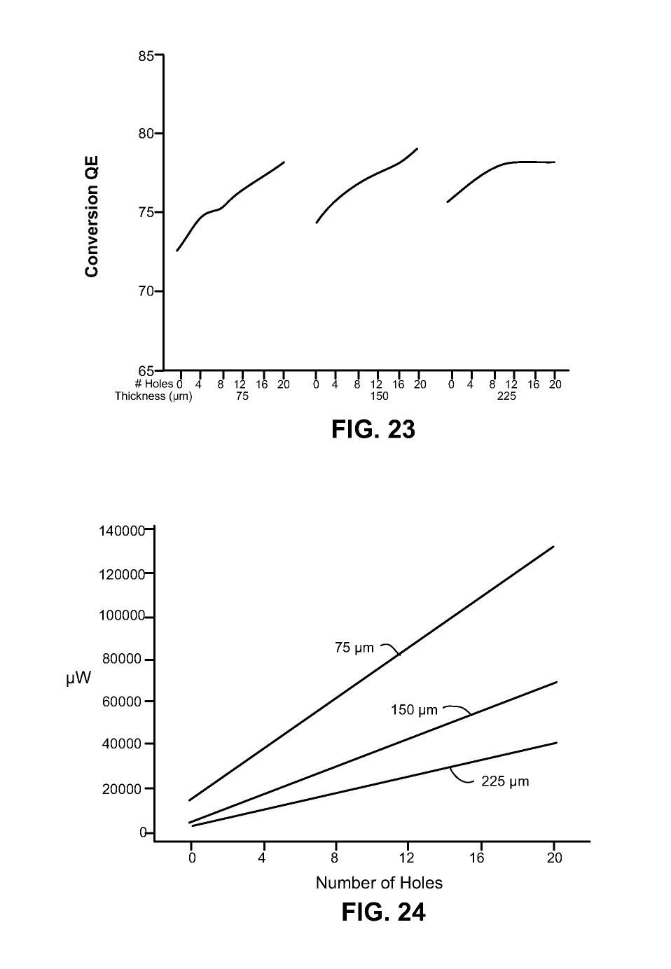

FIG. 23 plots individual values of conversion QE vs. thickness and holes, based on data measured from the samples in this batch. As shown, conversion QE tended to increase with the number of holes and/or with an increase in thickness. This may correlate a decrease in conversion QE with an increase in Cx value. Increasing the number of holes from 0 to 20 appeared to provide about the same increase in conversion QE, regardless of thickness.

FIG. 24 plots blue optical power (μW) vs. thickness and number of holes, based on data measured from the samples in this batch. As shown, the blue optical power in the spectra increased with the number of holes, with samples including 20 holes exhibiting the largest blue optical power. This is consistent with the hypothesis that holes produced in a converter may allow more unconverted blue primary light to pass through the converter. The effect of the number of holes on blue optical power was different for samples of different thickness, with the largest differences observed in the 75 μm data. Although not wishing to be bound by theory, it is believed that the large increase in blue optical power in these samples resulted from more unconverted blue primary light passing through the converter itself, rather than through one or more of the holes.

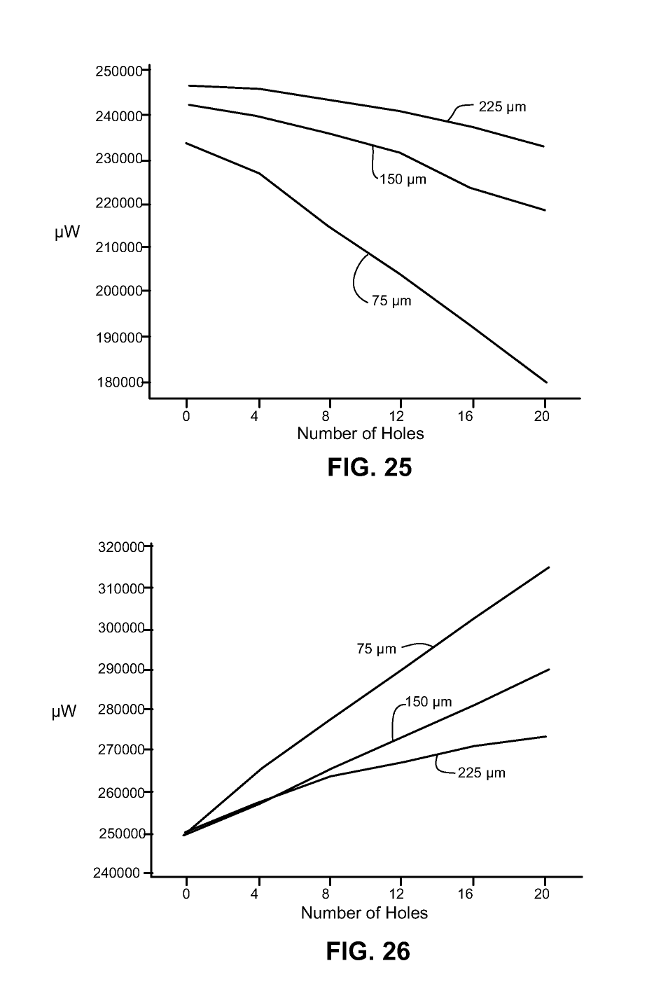

FIG. 25 plots yellow optical power (μW) vs. thickness and number of holes, based on data measured from the samples in this batch. As shown, the yellow optical power tended to decrease as the number of holes increased, and/or the thickness decreased. However, the rate at which yellow power decreased slowed as the sample thickness and//or the number of holes increased. The yellow optical power for the thin (75 μm) samples exhibited the largest decrease (e.g., about 1.5 to about 22.5%) in yellow optical power, whereas the thick (225 μm) samples exhibited the smallest decrease (e.g., about 0.5 to about 5.5%). Likewise, yellow optical power decreased more rapidly in the thin samples than it did in the thick samples. Of note is the fact that the yellow optical power did not increase with increasing number of holes, despite increases in the total emitting surface area provided by the holes.

FIG. 26 plots total optical power (μW) vs. thickness and number of holes, based on data measured from the samples in this batch. An increase in total optical power from the system was observed as the number of holes was increased from 0 to 4, 8, 12, 16, and 20. This is likely due to a net increase in the conversion efficiency of the system as the output color coordinates shift with increasing blue component. That is, the total optical power suggested that if the amount of blue primary light is held constant, a net increase in optical power output may be obtained by introducing holes into a converter.

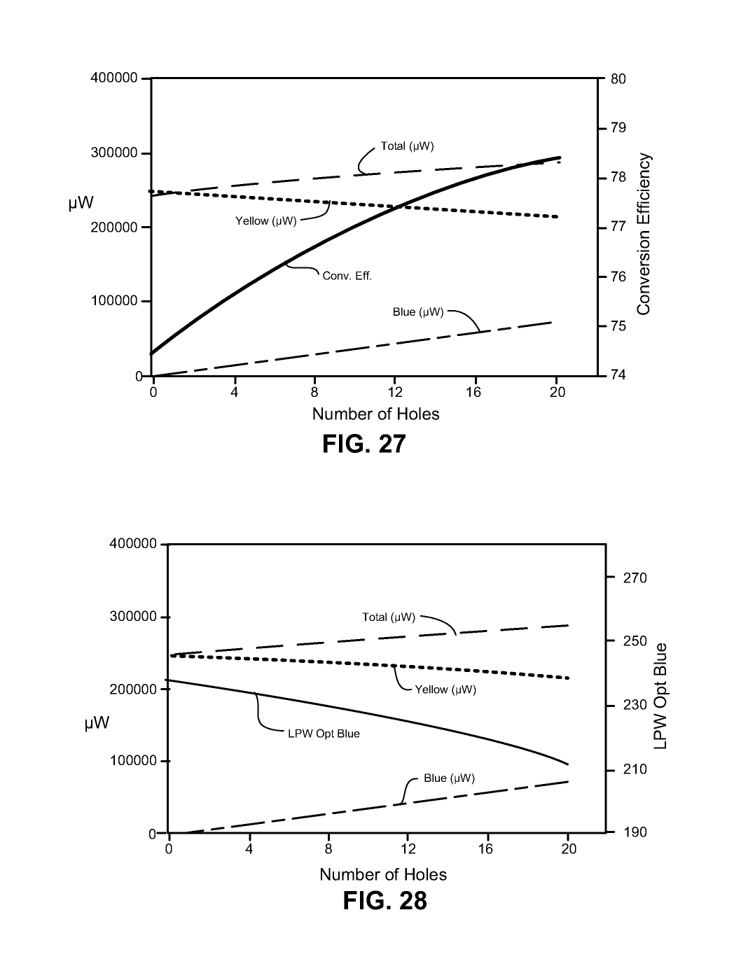

FIG. 27 plots a combination of the blue optical power, yellow optical power, total optical power, and conversion efficiency based on data measured from the 150 μm thick samples in this batch. FIG. 28 plots a combination of blue optical power, yellow optical power, total optical power, and LPW OPT Blue (lumens per watt of blue incident), based on data measured from the 150 μm thick samples in this batch. It is noted that conversion efficiency was calculated by dividing the amount of converted light from the converter/package (>470 nm) by the amount of blue light absorbed by the converter from the blue light source (<470 nm). The arrows in each of FIGS. 27 and 28 highlight trends (increasing or decreasing) in the data, relative to the number of holes. As shown in FIG. 27, conversion efficiency increased (e.g., about 0.5 to 5%) as the number of holes increased from 0 to 20. FIG. 28 demonstrates that while the total output optical power increased as the number of holes increased, LPW OPT blue decreased. It is believed that the reduction in LPW OPT blue is due to a decrease in yellow light output, which is consistent with the Cx data plotted in FIG. 21 for this thickness.

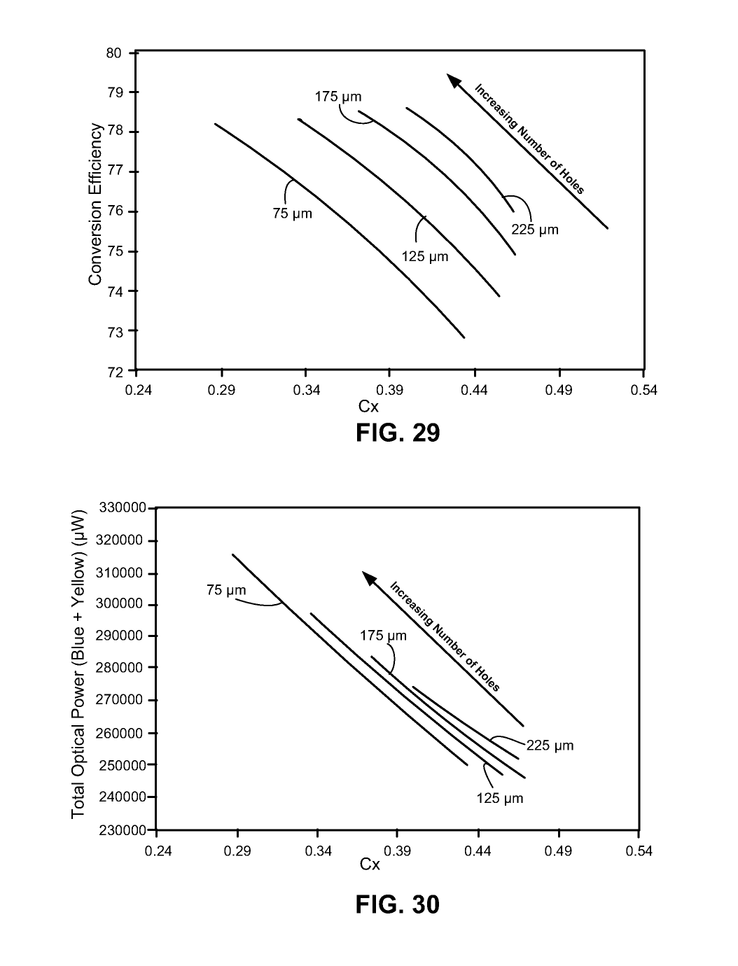

FIG. 29 plots conversion efficiency vs. Cx value for the samples having various thicknesses (75 μm, 125 μm, 175 μm, and 225 μm) and containing from 0 to 20 holes, based on data produced by the model. As indicated by the arrow in this FIG., thicker converters with more holes could achieve the same color point (Cx value), while simultaneously exhibiting higher conversion efficiency. The same observation holds true with respect to total optical power, which is plotted against Cx in FIG. 30.

As demonstrated above, converters consistent with the present disclosure may exhibit increased transmission of incident primary light, while substantially maintaining secondary light emission and luminous efficacy. In some instances, the “extra” primary light transmitted may be converted to additional more luminous or otherwise missing spectral components, thereby increasing luminous efficacy and/or Color Rendering Index (CRI). These gains may be attributable to more efficient utilization and extraction of the radiation an assembly containing an LED light source and a converter.

While the principles of the present disclosure have been described herein, it should be understood by those of ordinary skill in the art that this description is made only by way of example and not as a limitation as to the scope of the present disclosure. The features and aspects described with reference to particular embodiments disclosed herein are susceptible to combination and/or application with various other embodiments described herein. Such combinations and/or applications of such described features and aspects to such other embodiments are contemplated by the present disclosure, as though they were expressly described. Likewise, other exemplary embodiments consistent with the scope of the present disclosure, in addition to the exemplary embodiments expressly described herein. Modification and substitutions by one of ordinary skill in the art are considered to be within the scope of the present disclosure, which is not to be limited except by the following claims.

1-19. (canceled)

20. A light module comprising:
a solid-state light source configured to emit primary light from an emitting surface;
a wavelength conversion plate having a long dimension, d, at least one edge, a top surface, and a bottom surface wherein said bottom surface is in opposed facing relationship to said emitting surface;
said wavelength conversion plate comprising at least one wavelength conversion material and being configured to emit secondary light from said top surface in response to said primary light; and
said wavelength conversion plate further having a plurality of apertures formed therein wherein said apertures are positioned relative to said at least one edge by a distance that is less than or equal to about 20% of said long dimension, d.

21. The light module of claim 20, wherein said apertures are in the form of cavities in either the top or bottom surface.

22. The light module of claim 20, wherein said apertures are in the form of through holes that extend between the top and bottom surfaces.

23. The light module of claim 20, wherein said apertures are frustoconical in shape.

24. The light module of claim 23, wherein said apertures have a sidewall that extends from an open end at an angle α that ranges from about 25 to about 50°.

25. The light module of claim 20, wherein said solid-state light source comprises at least one of a light emitting diode, laser diode, or combination thereof, and said wavelength conversion material comprises at least one ceramic phosphor.

26. The light module of claim 20, wherein said plurality of apertures comprise cylindrical through holes that extend between said top surface and said bottom surface of said wavelength conversion plate, said cylindrical through holes having a radius, r, and a height, h, wherein h is equal to or greater than r.

27. A wavelength conversion structure for a light module including a solid-state light source that emits a primary light, said wavelength conversion structure comprising a wavelength conversion plate having a long dimension, d, at least one edge, a top surface, and a bottom surface wherein said bottom surface is in opposed facing relationship to said emitting surface;
said wavelength conversion plate comprising at least one wavelength conversion material and being configured to emit secondary light from said top surface in response to said primary light; and
said wavelength conversion plate further having a plurality of apertures formed therein wherein said apertures are positioned relative to said at least one edge by a distance that is less than or equal to about 20% of said long dimension, d.

28. The light module of claim 27, wherein said apertures are in the form of through holes that extend between the top and bottom surfaces.

29. The light module of claim 27, wherein said apertures are frustoconical in shape.

30. The light module of claim 29, wherein said apertures have a sidewall that extends from an open end at an angle α that ranges from about 25 to about 50°.
